(19) United States
(12) Patent Application Publication
(10) Pub. No.: US 2026/0014699 A1
(43) Pub. Date: Jan. 15, 2026

(54) SYSTEMS AND METHODS FOR AN IN-PIPE ROBOT WITH BISTABLE INFLATABLE FABRIC ACTUATORS

(71) Applicants: Weijia Tao, Mesa, AZ (US); Fuchen Chen, Mesa, AZ (US); Wenlong Zhang, Chandler, AZ (US)

(72) Inventors: Weijia Tao, Mesa, AZ (US); Fuchen Chen, Mesa, AZ (US); Wenlong Zhang, Chandler, AZ (US)

(73) Assignee: Arizona Board of Regents on Behalf of Arizona State University, Tempe, AZ (US)

(21) Appl. No.: 19/270,146

(22) Filed: Jul. 15, 2025

Related U.S. Application Data
(60) Provisional application No. 63/671,719, filed on Jul. 15, 2024.

(51) Int. Cl. B25J 9/14; B25J 9/00

(52) U.S. Cl. CPC B25J 9/142; B25J 9/0009

(57) ABSTRACT

A robot includes a pneumatic actuator unit with a bistable flexible device that improves the force and energy output capability of the robot. The flexible device is selectively configurable for setting the actuator unit in a contracted state or an extended state based on a fluid pressure within the actuator unit. The robot locomotes within a pipe structure by selectively inflating and deflating each respective actuator unit according to a periodic pressure command cycle.

### CROSS-REFERENCE TO RELATED APPLICATIONS

This is a U.S. Non-Provisional Patent Application that claims benefit to U.S. Provisional Patent Application Ser. No. 63/671,719 filed Jul. 15, 2024, which is herein incorporated by reference in its entirety.

### GOVERNMENT SUPPORT

This invention was made with government support under 2222816 awarded by the National Science Foundation. The government has certain rights in the invention.

### FIELD

The present disclosure generally relates to pipe inspection robots, and in particular, to a system and associated method for an inspection and blocking-clearage robot having bistable fabric actuators.

### BACKGROUND

Currently, utility pipes are inspected mainly by human operators, which can be risky, time consuming, and prone to inaccuracy and limited accessibility. To address these limitations, in-pipe robots are increasingly deployed to identify blockages, leaks, and structural damages.

However, there are challenges in designing robots that can pass through obstacles or narrow tunnels in the pipes, which is a critical requirement for pipe inspection robots. For example, water supply pipes may introduce partial blockage by mineral buildup from hard water, rust in older metal pipes, or sediment and water sewage pipes may be partially blocked by tree roots, trash, and rocks.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1A is an illustration showing a robot according to the present disclosure having bistable inflatable fabric actuators (BIFAs);

FIG. 1B is a photograph showing the robot of FIG. 1A in a fully contracted configuration;

FIG. 1C is a photograph showing the robot of FIG. 1A in a fully extended configuration;

FIGS. 2A and 2B are a pair of photographs respectively showing the robot within a large-diameter pipe (and assuming an extended configuration) and the robot within a small-diameter pipe (and assuming a contracted configuration);

FIG. 3 is a diagram showing sequential assembly of the robot of FIG. 1A;

FIGS. 4A-4C are a series of illustrations respectively showing an assembled actuator unit of the robot of FIG. 1A in an extended configuration, a “fully bent” (intermediate) configuration, and a contracted configuration;

FIGS. 5A and 5B are a pair of illustrations showing construction of a bistable spring of the robot of FIG. 3;

FIG. 6 is an illustration showing an assembled bistable inflatable fabric actuator (BIFA) of the robot of FIG. 1A;

FIGS. 7A-7C are a series of photographs showing three example variants of an actuator unit of the robot of FIG. 1A;

FIG. 8 is a diagram showing a control system of the robot of FIG. 1A;

FIG. 9 is a simplified block diagram showing an example computing device for implementation of aspects of the robot of FIG. 1A, including aspects of the controller of FIG. 8;

FIGS. 10A and 10B are a pair of diagrams respectively demonstrating a cross-sectional view of a BIFA of the robot of FIG. 1A transitioning between states and a pseudorigid body model (PRBM) of a branch of a bistable spring of the BIFA;

FIGS. 11A and 11B are a pair of graphical representations showing stiffness curves of the bistable laminate spring with different flexure rigidity EI based on the PRBM of FIG. 10B, and a peak force and energy output capability of the bistable laminate spring;

FIGS. 12A-12D are a series of graphical representations showing models of the BIFA from a single actuator with one end grounded to the same actuator (FIG. 12A) with a fixed object (FIG. 12B) or a free object (FIG. 12C), where FIG. 12D shows a model of the entire robot by ungrounding the actuator and adding friction caused by a head segment and a tail segment;

FIGS. 13A-13D are a series of photographs showing experimental setups for actuator characterization including: static loading (FIG. 13A), step response (FIG. 13B), impact (FIG. 13C), and push tests (FIG. 13D);

FIG. 14A is a photograph showing an experimental setup for a head anchoring test and FIG. 14B is a graphical representation showing resulting anchoring force of the robot head or tail segment;

FIG. 15 is a graphical representation showing experimental and simulated locomotion data for the robot with soft and stiff body actuators moving in a 6-inch pipe, including head displacement, pressures for the body, head, and tail actuators, and gait inputs;

FIGS. 16A-16D are a series of photographs showing experimental pipe setups for robot locomotion evaluation including a straight pipe (FIG. 16A), a 22.5 degree angle (FIG. 16B), a 45 degree angle (FIG. 16C), and a 90 degree angle (FIG. 16D);

FIG. 17 is a graphical representation showing stiffness curves from the static loading test of FIG. 13A with polynomial fit and PRBM prediction;

FIG. 18 is a graphical representation showing stiffness curves from the step response test of FIG. 13B with pressure and displacement data;

FIG. 19 is a graphical representation showing example force data from an impact experiment trial (FIG. 13C) when initial clearance is 40 mm;

FIG. 20 is a graphical representation showing impact and steady-state forces for the impact test (FIG. 13C) where the shaded region indicates data range of 5 trials performed;

FIG. 21 is a graphical representation showing transferred energy of the push experiment (FIG. 13D) where the shaded region indicates data range of trials performed;

FIG. 22A is a sequence of video screenshots showing demonstration of the robot of FIG. 1A hitting a spaghetti bundle within a pipe;

FIG. 22B is a sequence of video screenshots showing demonstration of the robot of FIG. 1A pushing a ball within a pipe;

FIG. 22C is a sequence of video screenshots showing demonstration of the robot of FIG. 1A traversing from a six-inch pipe into a four-inch pipe;

FIG. 22D is a sequence of video screenshots showing demonstration of the robot of FIG. 1A climbing up a vertical six-inch pipe;

FIG. 22E is a sequence of video screenshots showing demonstration of the robot of FIG. 1A climbing up a vertical six-inch pipe with a 3-kg load;

FIG. 22F is a sequence of video screenshots showing demonstration of the robot of FIG. 1A operating within a pipe filled with water, rocks, and tree branches;

FIGS. 23A and 23B are a pair of graphical representations showing comparison between robot locomotion data and CPG outputs for a baseline gait (FIG. 23A) and an optimized gait (FIG. 23B); and

FIG. 24 is a graphical representation showing extension and contraction step responses of the BIFA when different pressures are applied.

Corresponding reference characters indicate corresponding elements among the view of the drawings. The headings used in the figures do not limit the scope of the claims.

### DETAILED DESCRIPTION

Pipe inspection robots present a novel and efficient approach for detecting leaks or cracks, especially in environments that are harmful or inaccessible to humans. Compared to conventional rigid designs, pneumatic soft robots have emerged as promising alternatives thanks to their low cost, lightweight, mechanical compliance, and ease of waterproofing. However, they usually suffer from low power output limited by the materials and fabrication methods. The present disclosure outlines a robot having a new class of bistable inflatable fabric actuators (BIFAs), which leverage bistable structures to modulate the available pneumatic power for short-term high-power motions. A simplified yet accurate model was developed to understand the trade-offs between the speed and power output and guide the design of BIFAs and the in-pipe inspection robot. By incorporating strong bistability, the actuator achieves almost three times the impact force and five times the energy output compared to a weakly bistable variant with the same dimension and weight. Experiments demonstrate that the in-pipe robot built can traverse with an inchworm locomotion pattern in 4-in and 6-in pipes. One implementation of the robot (developed for validation) weighs only 284 g and has a top speed of 21 mm/s. The present disclosure also demonstrates the benefits of high-power motions in breaking and pushing away obstacles in pipes.

### I. Introduction

Utility pipes are critical infrastructure for continued economic growth and environmental safety, making it essential to conduct regular inspections of these critical infrastructures. Currently, these pipes are inspected mainly by human operators, which can be risky, time consuming, and prone to inaccuracy and limited accessibility. To address these limitations, in-pipe robots are increasingly deployed to identify blockages, leaks, and structural damages. Various pipe inspection robots that include primarily rigid components have been developed and can be classified based on their locomotion type: track, inchworm, screw, walking, wheel, and gauge. These rigid robots share many advantages, such as high speed, precision, and power, but they are also expensive, heavy, difficult to waterproof, and prone to getting stuck in the mud or other obstacles inside the pipe.

On the other hand, pneumatic soft robots have emerged as promising alternatives for pipe inspection because of their low cost, lightweight, mechanical compliance, and ease of waterproofing. Soft silicone rubber actuators have been used to build robots traveling with inchworm locomotion in straight, curved, and vertical pipes. These robots are also capable of underwater operation. Similarly, fabric-based actuators have also been employed to build an inchworm-inspired soft robot with even more compliance. Thanks to the large elongation ratio of silicone rubber, one robot has successfully demonstrated moving between pipes whose diameters differ by almost two times. The speed of this type of pipe robot can also be improved by reducing the actuator count and adding buckling elastic ribbons. Alternatively, the fast response of an origami-inspired soft-rigid hybrid contraction actuator can be leveraged for relatively fast in-pipe crawling.

Despite the numerous advancements of pneumatic soft in-pipe robots, they usually suffer from small power output, limiting their capabilities of generating high impact force to break or push away obstacles, which are useful for clearing the pipes for inspection and passage. The small power output is mostly due to their low operation pressures and flow rates, inherent limitations imposed by the soft materials, and corresponding fabrication methods. Although some of them have demonstrated capabilities of pushing loads much heavier than the robots' own weights, their locomotion speeds in those scenarios are relatively slow, resulting in overall low-power motions.

Instead of increasing the total power output and sacrificing the benefits of softness, using springs to temporarily store the pneumatic energy and release them rapidly at the correct timing is a more effective option to modulate the power and achieve short-term but useful high-power motions. A robot of the present disclosure leverages this power modulation using bistable structures. Instead of having one stable equilibrium state like most soft structures, bistable structures have two stable equilibria, resulting in a unique snap-through transition when deformed, during which the stored elastic energy is instantaneously released. This high-power behavior has already been shown to improve the locomotion speed, jumping height, and deployment time of various types of soft robots. Pneumatically actuated bistable structures are often achieved by combining molded silicone rubber shells with conventional metal springs, silicone rubber of different stiffness, and frustums made from plastic sheets. Unlike these previous works, the present disclosure uses laminate design and fabrication techniques to build bistable structures since laminate devices are low-cost, lightweight, and tunable. Furthermore, inflatable fabric pouches are used as the activation mechanism to keep the additional weight minimal, reduce energy loss, and simplify fabrication steps.

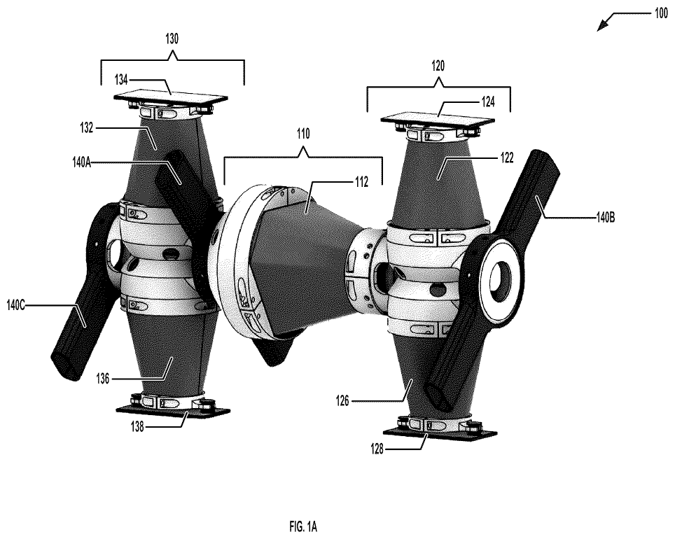

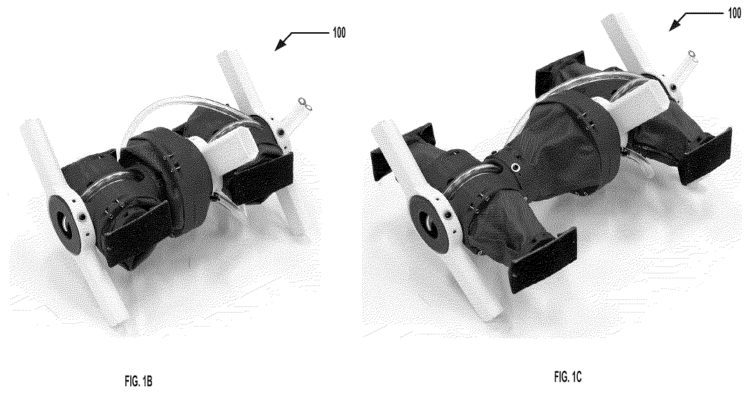

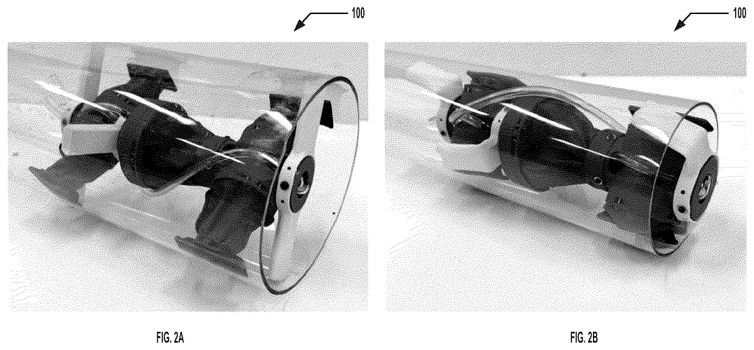

This work develops a novel bistable inflatable fabric actuator (BIFA) for in-pipe robots, as shown in FIGS. 1A-2B. By leveraging the snap-through behavior of bistable mechanisms, the actuator can store the energy from the pneumatics and release it instantly for a high-power motion. Compared to its weakly bistable counterpart, it can output almost three times the impact force when hitting objects or five times the transferred energy when pushing objects. The actuator is also lightweight, low-cost, customizable, water resistant, and has a relatively large deformation range. An example prototype robot, made from BIFAs, weighs only 284 g and operates in both 4-in and 6-in pipes.

Contributions of the present disclosure include:

A novel pneumatic actuator design with a bistable spring that improves force and energy output capability of a soft pneumatic in-pipe robot.

Simple but effective models based on masses, bistable springs, dampers, and pneumatic force generators for both the actuator and robot to capture their characteristics and performance.

A comparison of two actuator variants with weak and strong bistability demonstrated through simulation and experiments, uncovering the conditions for achieving the force and energy output amplification and tradeoffs with the robot operation speed.

The rest of this article is organized as follows. Section II first dives into the design and fabrication of BIFAs and the robot with their detailed modeling methods in Section III. Locomotion and gait optimization is discussed in Section IV. The experiments and results are respectively discussed in Sections V and VI. Finally, Section VII outlines comparison between the robot of the present disclosure and other pipe-interior crawling robots.

### II. Design

A prototype robot discussed herein for validation and shown in the figures weighs around 284 g. When fully extended, it is 225-mm long and fits inside a 157-mm circle. When fully contracted, it becomes 175-mm long and fits inside a 75-mm circle. It can move forward and backward in pipes with inchworm-type locomotion. As shown in FIGS. 1A-1C, the robot has three individually and pneumatically actuated segments: body, tail, and head. In an example implementation, the body segment includes one large BIFA, while the head and tail segments each include two small BIFAs. The number of actuators in the head and tail segments is kept at a minimum to reduce system complexity and weight. From preliminary tests, two actuators can provide enough anchoring force for the robot's operation. This robot also has flexible supports to remain in the center of the pipe during operation. The robot is designed to operate with pneumatic tethers.

### A. Robot Overview

FIG. 1A shows a robot 100 with a body having multiple segments, including a body segment 110, a head segment 120 engaged to a distal portion of the body segment 110, and a tail segment 130 engaged to a proximal portion of the body segment 110.

The body segment 110, the head segment 120, and the tail segment 130 each respectively include at least one actuator unit. As outlined herein, the body segment 110 includes a first actuator unit (e.g., a body actuator unit 112) of a plurality of actuator units, the head segment 120 includes a second actuator unit (e.g., a first head actuator unit 122) of the plurality of actuator units, and the tail segment 130 includes a third actuator unit (e.g., a first tail actuator unit 132) of the plurality of actuator units. Referring to FIGS. 1B and 1C, the actuator units of the robot 100 are selectively configurable between a contracted configuration (FIG. 1B) and an extended configuration (FIG. 1C). As outlined further herein, each actuator unit can be individually controlled by increasing or decreasing a fluid pressure within the respective actuator unit according to a periodic pressure command cycle, e.g., using a fluid pressure control device. FIGS. 1B and 1C show tubing connected to each respective actuator unit which can establish fluid flow communication with the fluid pressure control device as outlined herein. Further, note that in this context, “fluid” may encompasses gas (pneumatic) or liquid (hydraulic).

The first head actuator unit 122 of the head segment 120 includes a first foot 124 positioned along a distal portion of the first head actuator unit 122; likewise, the first tail actuator unit 132 of the tail segment 130 includes a second foot 134 positioned along a distal portion of the first tail actuator unit 132. As demonstrated in FIGS. 2A and 2B, the feet of the head segment 120 and the tail segment 130 can contact an interior surface of a pipe structure.

Continuing with FIG. 1A, the head segment 120 can include additional actuator units, including but not limited to a fourth actuator unit (e.g., second head actuator unit 126) having a proximal portion coupled to a proximal portion of the first head actuator unit 122. The second head actuator unit 126 can include a third foot 128 positioned along a distal portion of the second head actuator unit 126. In some examples, the second head actuator unit 126 is oriented substantially coplanar with the first head actuator unit 122. Further, the actuator units of the head segment 120 can be oriented substantially orthogonal to a direction of elongation of the body segment 110. In the example shown, the second head actuator unit 126 is oriented substantially parallel and 180 degrees relative to the first head actuator unit 122. The head segment 120 may optionally include additional actuator units, or fewer actuator units, and may be oriented at varying degrees relative to one another.

Likewise, the tail segment 130 can include additional actuator units, including but not limited to a fifth actuator unit (e.g., a second tail actuator unit 136) having a proximal portion coupled to a proximal portion of the first tail actuator unit 132. The second tail actuator unit 136 can include a fourth foot 138 positioned along a distal portion of the second tail actuator unit 136. In some examples, the second tail actuator unit 136 is oriented substantially coplanar with the first tail actuator unit 132. Further, the actuator units of the tail segment 130 can be oriented substantially orthogonal to a direction of elongation of the body segment 110. In the example shown, the second tail actuator unit 136 is oriented substantially parallel and 180 degrees relative to the first tail actuator unit 132. The tail segment 130 may optionally include additional actuator units, or fewer actuator units, and may be oriented at varying degrees relative to one another.

In a further aspect, the body segment 110 can optionally include additional actuator units which may be individually articulatable, and may be oriented substantially parallel with one another in series. Optionally, the body segment 110 can include more than one actuator unit which may be oriented at different angles relative to one another. This can enable increased control over length and/or shape of the body segment 110. Further, the robot 100 can include additional segments resembling the head segment 120 and the tail segment 130 which may be positioned intermediately between two or more actuator units of the body segment 110.

In addition, as shown in FIG. 1A, the robot 100 can include one or more rotors (e.g., body rotor 140A, head rotor 140B, and tail rotor 140C) which are rotatable about a first axis corresponding with a direction of elongation of the body segment 110. Rotation of the rotors can be controlled by one or more motors (not shown in FIG. 1A). As discussed further herein, each rotor defines a member (also referred to herein as a “support member”) that is biased toward a straightened configuration, but is configured to elastically buckle upon application of an external force exceeding a threshold magnitude. This is demonstrated between FIGS. 2A and 2B. When in the larger-diameter pipe of FIG. 2A, the rotors of the robot 100 are not constricted and are thus allowed to expand towards their default, straightened configuration. When in the smaller-diameter pipe of FIG. 2B, the rotors of the robot 100 elastically buckle upon application of an external force (e.g., force jointly applied by the interior surface of the pipe and by forward motion of the robot 100) exceeding the threshold magnitude. The rotors may subsequently return to their default position once the pipe diameter allows. Note that while the rotors are capable of motorized rotation, actual locomotion of the robot 100 is made possible by increasing and decreasing fluid pressures within each respective actuator unit according to a periodic pressure command cycle as discussed further herein.

### B. Bistable Fabric Actuator Unit

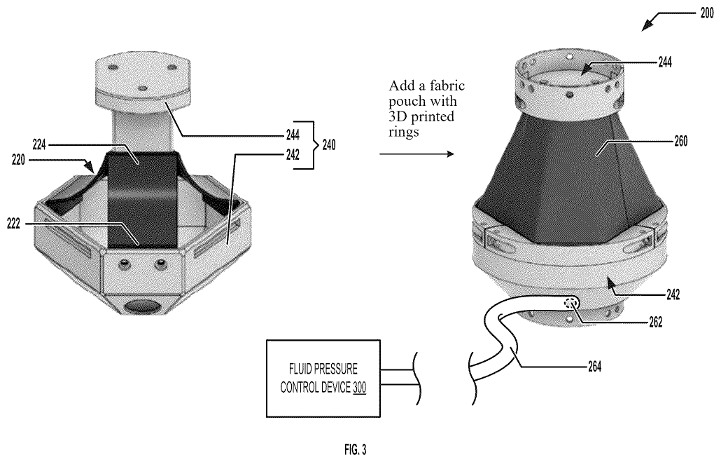

FIG. 3 demonstrates a general sequence for construction of an actuator unit 200 of the plurality of actuator units. Actuator unit 200, also referred to herein as “BIFA” correlates with one or more of: the body actuator unit 112, first head actuator unit 122, second head actuator unit 126, first tail actuator unit 132, second tail actuator unit 136 of the robot 100 of FIG. 1A.

As shown in FIG. 3, the actuator unit 200 includes a flexible device 220 (also referred to herein as a “flexible laminate device”) coupled to a base unit 240. The flexible device 220 acts like a bistable spring which can selectively transition the actuator unit 200 between a contracted state and an extended state, as outlined further herein. The base unit 240 couples to respective portions of the flexible device 220 as discussed further herein, and provides structures for supporting the flexible device and coupling to other components of the robot 100. Further, the actuator unit 200 includes a balloon 260 spanning respective portions of the base unit 240 that can be in fluid flow communication with a fluid pressure control device 300 for selectively configuring the flexible device 220 into a contracted state or an extended state.

The flexible device 220 includes a first portion 222 and a second portion 224. As outlined further herein, the flexible device 220 can include a plurality of members linked at the second portion 224, where free ends of the respective members define the first portion 222. The flexible device 220 can be constructed of a laminate material; an example composition and construction process is outlined further herein.

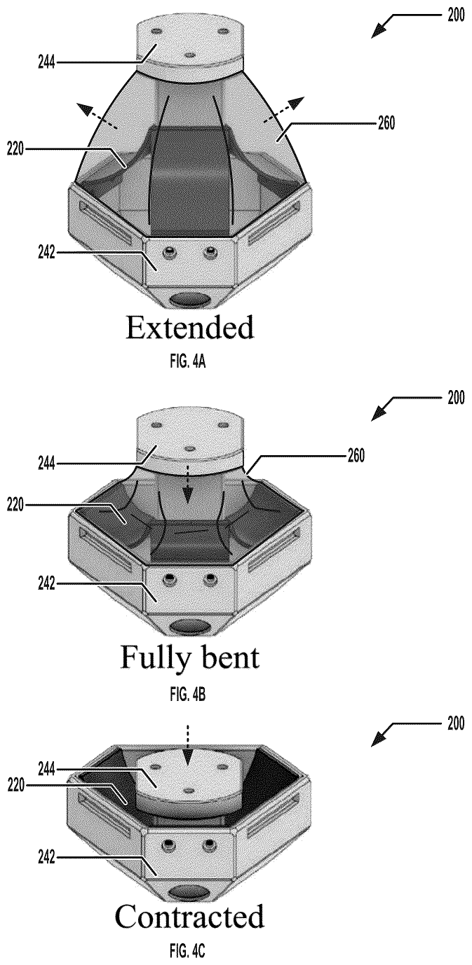

The base unit 240 includes a first connector 242 coupled to the first portion 222 of the flexible device 220, and a second connector 244 coupled to the second portion 224 of the flexible device 220. The first connector 242 corresponds with a proximal portion of the actuator unit 200 and the second connector 244 corresponds with a distal portion of the actuator unit, as recited above with respect to the robot 100 of FIG. 1A. As demonstrated in further detail herein with respect to FIGS. 4A-4C, when the actuator unit 200 is in the contracted state, the second connector 244 nests within the first connector 242 of the base unit 240 and the second portion 224 of the flexible device 220 extends inward relative to the first connector 242. When the actuator unit 200 is in the extended state, the second connector 244 extends away from the first connector 242 and the second portion 224 of the flexible device 220 extends outward relative to the first connector 242.

As further shown in FIG. 3, the balloon 260 spans the first connector 242 and the second connector 244 of the base unit 240. The balloon 260 is in fluid flow communication with the fluid pressure control device 300 by an aperture 262 (shown positioned along the first connector 242) in communication with tubing 264. The fluid pressure control device 300 controls actuation of the actuator unit 200 into a contracted state or an extended state by increasing or decreasing a fluid pressure within the balloon 260, causing expansion or compression of respective portions of the base unit 240 and a change in state of the flexible device 220.

FIGS. 4A-4C demonstrate how the actuator unit 200 changes states responsive to fluid pressure within the actuator unit 200 (note that in FIG. 4C the balloon 260 is not shown, but can be assumed to be folded up as in FIG. 1B). Referring to FIG. 4A, increasing fluid pressure within the balloon 260 (i.e., inflating) applies an expansion force between the first connector 242 and the second connector 244, which can transition the flexible device 220 into the extended state (due to bistability of the flexible device, discussed herein) and push or otherwise fully extend the second connector 244 away from the first connector 242. In the extended state, the second portion of the flexible device 220 extends outward relative to the first connector 242.

Conversely, as shown in the sequence of FIGS. 4B and 4C, decreasing fluid pressure within the balloon 260 (i.e., deflating) collapses the second connector 244 into the first connector, which transitions the flexible device 220 into the contracted state. Consequently, the second connector 244 nests within the first connector 242, and the second portion of the flexible device 220 extends inward relative to the first connector 242.

### C. BIFA Construction

As discussed, an example implementation of the BIFA (e.g., actuator unit 200) includes three main components: 1) a flexible laminate device (flexible device 220) that acts like a bistable spring; 2) a fabric pouch (balloon 260) as an airtight chamber; and 3) a 3-D printed connecting structure (base unit 240).

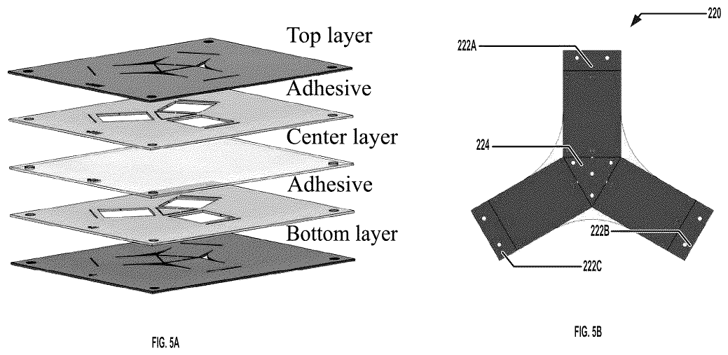

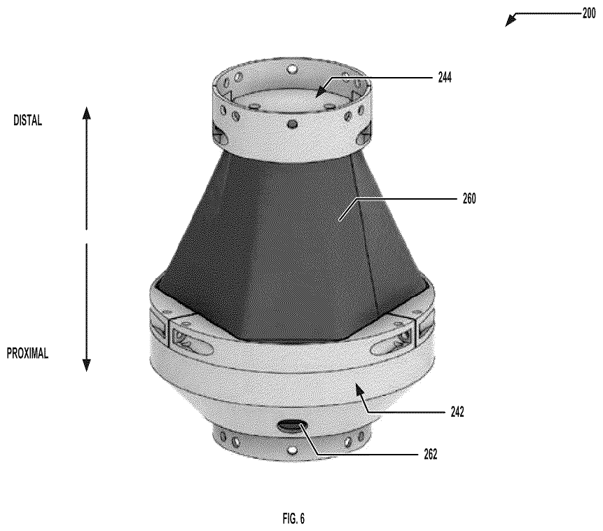

1) Laminate Bistable Spring: As shown in FIGS. 5A and 5B, the flexible device 220 has three identical branches, each of which has three links connected with flexure joints that behave like hinges. It is folded and fixed onto a 3-D printed base. Since the middle link of each branch is designed to be flexible, a force along the axial direction will deform the laminate device and make it switch between contracted and extended configurations, which are the two stable states of this bistable spring. During the transition, energy is first stored inside the bent flexible links and then quickly released after the center of the branches passes through the middle point, which is the unstable equilibrium state where all the flexible links are fully bent.

As shown in FIG. 5A, the laminate device is made from five layers of materials. The top and bottom layers are thicker for forming the links. The center layer is thinner to serve as the flexure joints when all other layers are removed. Two adhesive layers are used to bond the other three layers. To fabricate the device, Each layer is first individually laser cut and then laminated together with a heat press. Afterward, A final cut is performed to release the device from its support materials.

In FIG. 5B, the first portion of the flexible device 220 encompasses free ends 222A-220C of respective members of the flexible device 220. These free ends 222A-222C couple with first connector 242 of the base unit 240 previously discussed with respect to FIG. 3. The second portion 224 of the flexible device 220 likewise couples with second connector 244 of the base unit 240.

2) Fabric Pouch: As shown in FIG. 6, a fabric pouch is added as the balloon 260 spanning the first connector 242 and the second connector 244 to actuate the flexible device 220. First, a heat-sealable 200-Denier Oxford nylon fabric sheet (Rockywoods, SAM6607) is laser cut and sealed with an impulse sealer (ULINE, H-86) into a pocket, where the laminate device, along with the base, is inserted. Then, a tube fitting (McMaster-Carr, 5463K53) (e.g., tubing 264 of FIG. 3) is installed onto the fabric with a metal-bounded sealing washer (McMaster-Carr, 93786A100) and nut, after which the pocket is sealed off. Finally, 3-D printed rings with ridges that match the grooves on the base wrap around the two ends of the fabric pouch and lock it. In this way, positive pressure inside the pouch will push the flexible device 220 from the contracted state to the extended state. Similarly, a negative pressure can pull the flexible device 220 back.

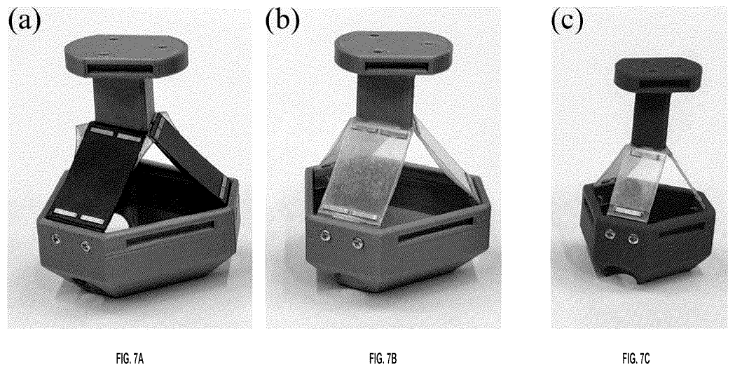

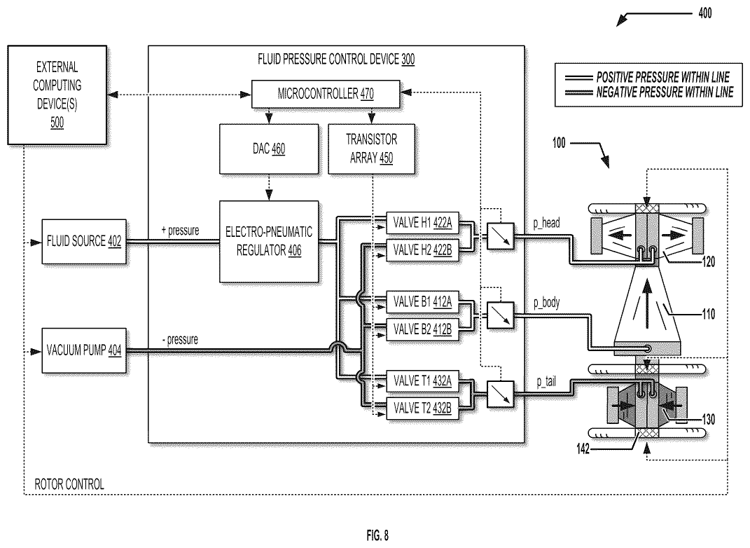

3) BIFA Variants: As shown in FIGS. 7A-7C, three variants of BIFAs are made: A small variant for the head and tail of the robot and two large variants that have different strengths of bistability for the body of the robot. The head and tail actuators and the soft body actuator all use 0.26-mm polyester sheets (Grafix, Clear Dura-La) for the top and bottom layers of the laminate device and 0.18-mm polyester sheet for the middle layer. For the laminate device inside a stiff body actuator, the top and bottom layers are 0.45-mm and 0.26-mm fiberglass sheets (ACP Composites, G-10/FR4). Its middle layer is a 0.26-mm polyester sheet. The same 0.015-mm adhesive layer material (Drytac, MHA) is used for all actuators. For the head and tail actuators, each one is also attached with 3-D printed feet made from thermoplastic polyurethane (Ultimaker, TPU 95 A) covered with friction tape.

### D. Support Members

The flexible supports have tube-like structures and are 3-D printed with the same TPU material as the one for the feet. This structure will buckle when a relatively small force is applied, after which it behaves like two links connected by a hinge joint with small torsional stiffness. In this way, when the robot needs to squeeze through a narrow pipe, it only needs to overcome the buckling force of the supports and a small friction force inside the tunnel. When coming out of the tunnel, the supports will bounce back to their initial shape and make sure the robot is always aligned with the pipe. The states of the supports in large and small pipes are compared FIGS. 2A and 2B.

Preliminary tests suggest that two branches of the shown geometry for each support are stiff enough to keep the robot along the pipe centerline. Adding more branches will increase the resistance during normal locomotion and squeezing into smaller pipes, and the robot's total weight.

### E. Control System

FIG. 8 shows an example implementation of a control system 400 for actuation of the robot 100 and collection of sensory data. A fluid pressure control device 300 (also referred to herein as a “pneumatic subsystem”) takes both positive and negative pressure and outputs three binary pressures that are individually addressable. The positive pressure is provided by a fluid source 402 and goes through an electro-pneumatic regulator 406 (SMC, ITV1050-21N2CL4). The negative pressure comes from a vacuum pump 404 (Agilent, DS 202), and no regulator is installed. For each output, two solenoid valves (Festo, MHE3-MS1H-3/2G-1/8-K) are used to switch between positive and negative pressure (shown for each of the three binary pressures). A pressure sensor (Honeywell, ABPDRRV015PDAA5) that can read both positive and negative pressure is also added to each output near the valves and away from the robot, which greatly simplifies the wiring. The main electronics of the system include MOSFETs (transistor array 450) driving the valves, a DAC 460 (Adafruit, MCP4725) for the regulator, a microcontroller 470 (Arduino, Uno) handling the low-level logic, and a computing device 500 issuing commands and collecting data. In addition, computing device(s) 500 can supply rotor control signals to one or more motors 142 associated with rotors.

As shown, the body segment 110 of the robot 100 communicates with a body pressure line represented by p_body (through tubing). Likewise, the head segment 120 of the robot 100 communicates with a head pressure line represented by p_head, and the tail segment 130 of the robot 100 communicates with a tail pressure line represented by p_tail.

The microcontroller 470 and transistor array 450 control the valves which modulate the output pressure for each respective pressure line. The body pressure line p_body communicates with a first valve indicated by “valve B1 412A” and a second valve indicated by “valve B2 412B”. First valve B1 412A communicates with a positive-pressure output of the electro-pneumatic regulator 406, while second valve B2 412B communicates with a negative-pressure output of the vacuum pump 404. To induce a positive pressure within the body segment 110, the microcontroller 470 and transistor array 450 open the first valve B1 412A (the positive valve) and close the second valve B2 412B (the negative valve), resulting in a positive pressure within body pressure line p_body. Conversely, to induce a negative pressure within the body segment 110, the microcontroller 470 and transistor array 450 close the first valve B1 412A (the positive valve) and open the second valve B2 412B (the negative valve), resulting in a negative pressure within body pressure line p_body. In the example of FIG. 8, the body segment 110 is in the expanded state.

Likewise, the head pressure line p_head communicates with a first valve indicated by “valve H1 422A” and a second valve indicated by “valve H2 422B”. First valve H1 422A communicates with a positive-pressure output of the electro-pneumatic regulator 406, while second valve H2 422B communicates with a negative-pressure output of the vacuum pump 404. To induce a positive pressure within the head segment 120, the microcontroller 470 and transistor array 450 open the first valve H1 422A (the positive valve) and close the second valve H2 422B (the negative valve), resulting in a positive pressure within head pressure line p_head. Conversely, to induce a negative pressure within the head segment 120, the microcontroller 470 and transistor array 450 close the first valve H1 422A (the positive valve) and open the second valve H2 422B (the negative valve), resulting in a negative pressure within head pressure line p_head. In the example of FIG. 8, the head segment 120 is in the expanded state.

The tail pressure line p_tail communicates with a first valve indicated by “valve T1 432A” and a second valve indicated by “valve T2 432B”. First valve T1 432A communicates with a positive-pressure output of the electro-pneumatic regulator 406, while second valve T2 432B communicates with a negative-pressure output of the vacuum pump 404. To induce a positive pressure within the tail segment 130, the microcontroller 470 and transistor array 450 open the first valve T1 432A (the positive valve) and close the second valve T2 432B (the negative valve), resulting in a positive pressure within tail pressure line p_tail. Conversely, to induce a negative pressure within the tail segment 130, the microcontroller 470 and transistor array 450 close the first valve T1 432A (the positive valve) and open the second valve T2 432B (the negative valve), resulting in a negative pressure within tail pressure line p_tail. In the example of FIG. 8, the tail segment 130 is in the contracted state.

The solenoid valves may remain open/closed to continue to supply positive or negative pressure following transition of the associated actuator units. This may provide robustness to external forces which could unintentionally collapse actuator units. Alternatively, to save on power, both solenoid valves within a pairing can shut off following transition of the associated actuator units to the desired state. However, during a continuous locomotion sequence, the solenoid valves may be continually operated according to a periodic pressure command cycle as outlined herein.

### F. Computing Device

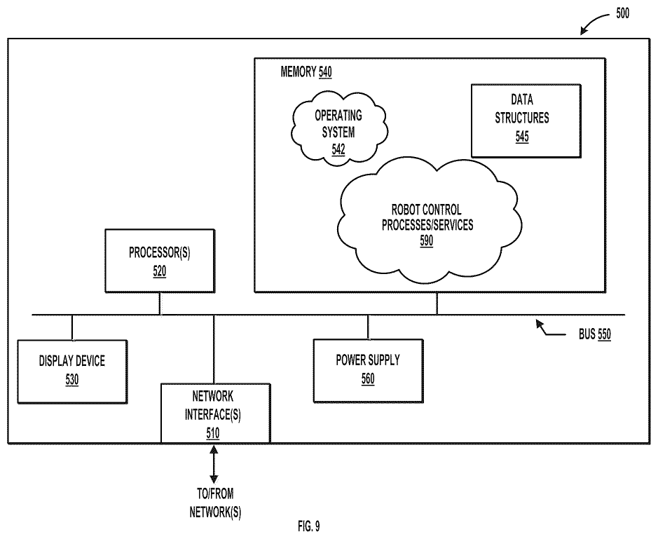

FIG. 9 is a schematic block diagram of a computing device 500 that may be used with one or more embodiments described herein, e.g., as a component of control system 400 as computing device 500 and/or microcontroller 470 shown in FIG. 8 for controlling aspects of robot 100.

Device 500 comprises one or more network interfaces 510 (e.g., wired, wireless, PLC, etc.), at least one processor 520, and a memory 540 interconnected by a system bus 550, as well as a power supply 560 (e.g., battery, plug-in, etc.). Device 500 can also include or otherwise communicate with a display interface device 530 which can include one or more input/output devices that enable a user to input data, and to view or otherwise access output data. Input/output devices can include but are not limited to a monitor, a touch-screen, a speaker, a keyboard, a mouse, and the like.

Network interface(s) 510 include the mechanical, electrical, and signaling circuitry for communicating data over the communication links coupled to a communication network. Network interfaces 510 are configured to transmit and/or receive data using a variety of different communication protocols. As illustrated, the box representing network interfaces 510 is shown for simplicity, and it is appreciated that such interfaces may represent different types of network connections such as wireless and wired (physical) connections. Network interfaces 510 are shown separately from power supply 560, however it is appreciated that the interfaces that support PLC protocols may communicate through power supply 560 and/or may be an integral component coupled to power supply 560.

Memory 540 includes a plurality of storage locations that are addressable by processor 520 and network interfaces 510 for storing software programs and data structures associated with the embodiments described herein. In some embodiments, device 500 may have limited memory or no memory (e.g., no memory for storage other than for programs/processes operating on the device and associated caches). Memory 540 can include instructions executable by the processor 520 that, when executed by the processor 520, cause the processor 520 to implement aspects of the system and the methods outlined herein.

Processor 520 comprises hardware elements or logic adapted to execute the software programs (e.g., instructions) and manipulate data structures 545. An operating system 542, portions of which are typically resident in memory 540 and executed by the processor, functionally organizes device 500 by, inter alia, invoking operations in support of software processes and/or services executing on the device. These software processes and/or services may include robot control processes/services 590, which can include aspects of the methods and/or implementations of various modules described herein. Note that while robot control processes/services 590 is illustrated in centralized memory 540, alternative embodiments provide for the process to be operated within the network interfaces 510, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the robot control processes/services 590 is shown as a standalone process, those skilled in the art will appreciate that this process may be executed as a routine or module within other processes.

### III. Modeling

This section first describes the model for deriving the stiffness curve of the bistable laminate spring inside a BIFA. Then, since the motion of a BIFA is mostly linear extension and contraction, a 1-D reduced-order model is developed to describe and simulate its dynamics. It is also augmented with a simple contact model to interact with a fixed or free object for scenarios when the actuator is anchoring to the pipe wall or pushing debris inside the pipe. Finally, the actuator model is also extended by adding friction forces from anchoring to simulate the full robot locomotion along a pipe's axis.

### A. Bistable Laminate Spring

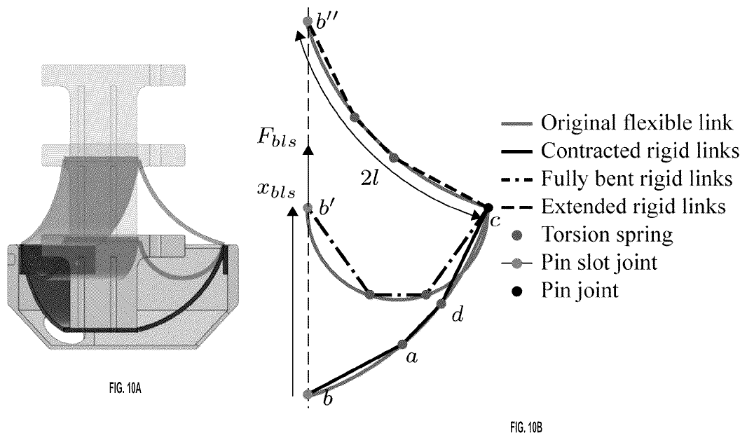

As shown in FIG. 10A since the laminate spring has three identical branches and its center is constrained to move along the center axis, the present disclosure models only one-third of the laminate spring, which can be considered as a curved beam with a pin joint at one end and a pin slot joint at the other end. As shown in FIG. 10B, the pseudorigid-body model (PRBM) for initially curved pinned-pinned segments is utilized to convert this flexible beam into three rigid links connected by two torsion springs so that analysis can be performed on a simpler linkage system instead of a curved beam with large deformation. The length of the two longer links is l_{ab}=l_{cd}=pl and the length of the short link is l_{ad}=(1−γ)l, where l is half of the length of the original curved beam, and ρ and γ are constants determining the ratios between the three links and depend on the initial curvature of the beam. For a nondimensionalized curvature κ₀=0.5 that roughly matches the prototype, ρ=0.791 and γ=0.793. The spring constant of the torsion springs marked as the red dots in FIG. 10B is

$$k = ρ {K}_{Θ} \frac{EI}{l} \qquad ( 1 )$$

where K_{↓}=2.59 is the spring stiffness coefficient. EI is the flexural rigidity of the beam. Since there is no adhesive between the flexing layers of the laminate, one can assume that each layer bends along its own neutral axis and

$$EI = \sum {E}_{i} \frac{w {t}_{i}^{3}}{12} \qquad ( 2 )$$

where Eᵢ is the material's Young's modulus for that layer, w is the link width, and tᵢ is the layer thickness. Adhesive layers may be ignored since they are very thin and provide near-zero stiffness.

Once the spring constants and link lengths are determined through (1) and (2), a static force analysis of the linkages in FIG. 10B produces the relationship between the applied axial force F_{bls} and displacement x_{bis} as

$${F}_{bls} = 3 {bls}_{} ( {x}_{bls} ) \qquad ( 3 )$$

where K_{bis} represents the stiffness curve and its detailed equations are omitted. The constant 3 is to account for all the three branches.

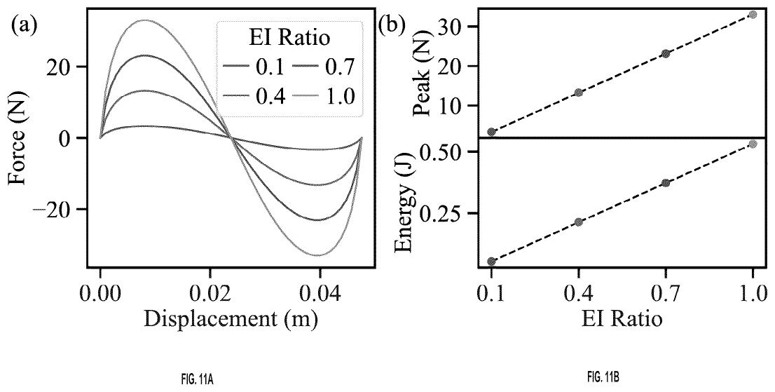

The above PRBM enables studying the relationship between the stiffness curve of the bistable laminate spring and the design parameters. The stiffness curves for several different flexure rigidity EI as in (2) are plotted in FIG. 11A. The stiffest curve is calculated from the values of the stiff body actuator variant as listed in Section II-C-3 and Table V. The remaining ones are 0.7, 0.4, and 0.1 times its EI, respectively. In practice, EI can be tuned by adjusting the width, thickness, and materials of the branches. For reference, the EI of the soft body actuator variant is 0.18 times that of the stiff variant.

As expected, the curve has a sine-wave-like shape with two stable equilibria at the ends and an unstable one in the middle. Moreover, EI affects both the peak force and energy storage or output capabilities of the springs. As plotted in FIG. 11B, they are linearly proportional to EI, and increasing them is the key to enabling short-term high-power motions for the actuator and amplifying its force and energy output capabilities, which is shown in Sections VI-A-3 and VI-A-4.

It should be noted that changing the link length l can also affect the shape of the stiffness curves and, as a result, the actuator's performance, since it can be viewed as a modifier for EI as in (1). Although decreasing l increases the stiffness, the displacement range or the stroke of the actuator also decreases, which may not be desirable. This work focuses on improving the actuator's performance while keeping the stroke length constant. The study of the more complex interaction is an interesting direction for the future.

### B. Actuator

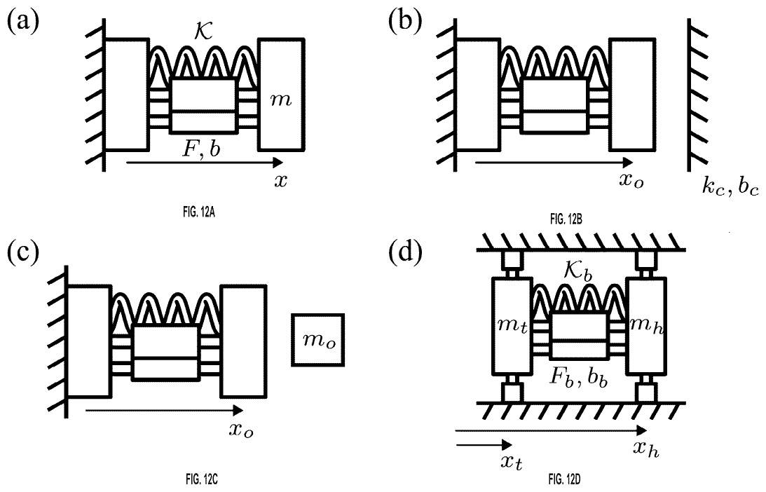

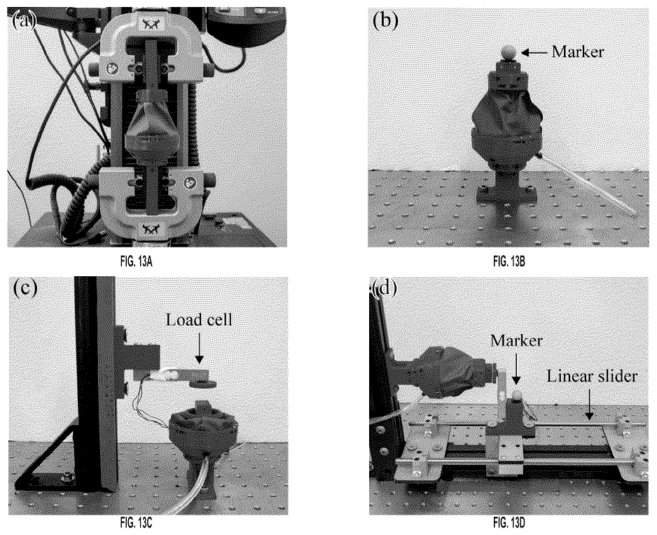

As shown in FIG. 12A, a BIFA can be modeled as two masses connected with a bistable spring, a damper, and a force generator in parallel. The damping mainly comes from the air movement inside the actuator, along with some from the laminate spring. The force generator represents the pneumatic force within the actuator.

First, one end of the actuator is fixed to focus on the equations of motion for one of the masses. This constraint will be released when modeling the entire robot. The dynamics for one of the masses are described with the following equations:

$$m \ddot{x} = - ( x ) - b \dot{x} + F - G , \qquad ( 4 )$$

$$b = \{ \begin{matrix}{b}_{n} , & < 0 \\ {b}_{p} , & otherwise\end{matrix} , \qquad ( 5 )$$

$$\dot{F} = α ( ( t - τ ) α - F ) , \qquad ( 6 )$$

$$τ = \{ \begin{matrix}{τ}_{n} , & < 0 \\ 0 , & otherwise\end{matrix} \qquad ( 7 )$$

where x represents the displacement and m is roughly half of the actuator's mass. [symbol] represents the stiffness curve, b is the damping constant, and G is the gravitational term which depends on the orientation of the actuator. Furthermore, two different damping values are necessary to account for the different behaviors when positive and negative pressure are applied, as shown in (5).

Since the exact pneumatic dynamics is complex and depends on many factors such as the compressor characteristics, tube length and diameter, and air chamber volume and shape, a first-order model (6) with a convergence factor α is used to model the rising and dropping of pneumatic forces, where the change rate of force \dot{F} is linearly proportional to the error between the desired and the current force. The desired force equals the desired pressure [symbol] (t−τ) times a nominal cross-section area α. It also has a time delay τₙ when a negative pressure is applied, as shown in (7). This delay was discovered during initial tests. This is mostly likely related to the fabric pouch being larger than the inner structure when fully inflated and vacuuming the extra air takes time.

Lastly, the pressure inside the actuator can be estimated as p=(F−b\dot{x})/a, which is the pressure-related forces divided by the area. This is useful for comparing the model's prediction against readings from the actual pressure sensors.

### C. Contact

1) Fixed Object: To describe the actuator hitting a fixed object as shown in FIG. 12B, a contact force is added to the right side of (4) and is modeled as a one-way spring and damper as follows:

$$m \dot{x} = - ( x ) - b \dot{x} + F - G + {F}^{c} , \qquad ( 8 )$$

$${F}^{c} = \{ \begin{matrix}min ( - {k}_{c} ( x - {x}_{o} ) - {b}_{c} \dot{x} , 0 ) , & x > {x}_{c} \\ 0 , & otherwise\end{matrix} \qquad ( 9 )$$

where k_{c} and b_{c} are the spring and damping coefficients, and xₒ is the distance between the object and the actuator's base.

2) Free Object: When the actuator is hitting a free object as shown in FIG. 12C, the contact force can be defined similarly

$${F}_{c} = \{ \begin{matrix}min ( - {k}_{c} ( x - {x}_{o} ) - {b}_{c} ( \dot{x} - {\dot{x}}_{o} ) , 0 ) , & x > {x}_{o} \\ 0 , & otherwise\end{matrix} \qquad ( 10 )$$

and the equation of motion of the free object is mₒ\ddot{x}ₒ=F^{c}.

### D. Robot

The model of the entire robot can be considered as an actuator model with additional friction induced by anchoring of its head and tail, as shown in FIG. 12D. The two masses in the actuator model now represent the lumped masses of the head and tail assembly and half of the body actuator. Both of them are free to move now, unlike in previous sections. The equations of motion for the head mass are shown:

$${m}_{h} {\ddot{x}}_{h} = {b}_{} ( {x}_{h} - {x}_{t} ) - {b}_{b} ( {\dot{x}}_{h} - {\dot{x}}_{t} ) + {F}_{b} - {f}_{h} , \qquad ( 11 )$$

$${f}_{h} = \{ \begin{matrix}sign ( {\dot{x}}_{h} ) {μ}_{k} {N}_{h} , & \vert {\dot{x}}_{h} \vert > ϵ \\ sign ( {F}_{n}^{′} ) min ( {μ}_{s} {N}_{h} , \vert {F}_{h}^{′} \vert ) , & otherwise\end{matrix} , \qquad ( 12 )$$

$${N}_{h} = 2 {F}_{h}^{c} + {G}_{h} , \qquad ( 13 )$$

$${F}_{h}^{′} = - {k}_{b} ( {x}_{h} - {x}_{t} ) - {b}_{b} ( {\dot{x}}_{h} - {\dot{x}}_{t} ) + {F}_{b} \qquad ( 14 )$$

where xₕ and xₜ represent the position of the head and tail, [symbol] _{b} is the stiffness function of the body BIFA, bb is the damping constant similar to (5), F_{b} is the pneumatic force similar to (6), and fₕ is the friction exerted on the head.

As shown in (12), both kinetic and static friction are modeled, which are switched by a small speed threshold e and have different friction coefficients μₖ and μₛ. The normal force Nₕ that causes the friction has two components: 1) the contact force Fₕ^{c} due to the head actuators hitting the fixed pipe wall; and 2) the gravitational force Gₕ related to the orientation of the pipe and robot as shown in (13). The head contact force comes from (8). To reduce complexity, only one set of equations is used and the contact force is doubled, even though the head actually contains two actuators.

Similar to (11), the equations of motion for the tail mass is

$${m}_{t} {\ddot{x}}_{t} = {b}_{} ( {x}_{t} - {x}_{h} ) - {b}_{b} ( {\dot{x}}_{t} - {\dot{x}}_{h} ) - {F}_{b} - {f}_{t} . \qquad ( 15 )$$

In summary, the entire robot model has a total of eleven states for the head, tail, and body actuator and takes three desired time-delayed pressure inputs, which can be written in the following state-space form:

$$[ \begin{matrix}{\dot{X}}_{b} \\ {\dot{X}}_{ha} \\ {\dot{X}}_{ta}\end{matrix} ] = f ( [ \begin{matrix}{X}_{b} \\ {X}_{ha} \\ {X}_{ta}\end{matrix} ] , [ \begin{matrix}{b}_{} ( t - {τ}_{b} ) \\ {ha}_{} ( t - {τ}_{ha} \\ {ta}_{} ( t - {τ}_{ta}\end{matrix} ] ) , \qquad ( 16 )$$

$${X}_{b} = {[ \begin{matrix}{x}_{h} & {\dot{x}}_{h} & {x}_{t} & {\dot{x}}_{t} & {F}_{b}\end{matrix} ]}^{T} , \qquad ( 17 )$$

$${X}_{ha} = {[ \begin{matrix}{x}_{ha} & {\dot{x}}_{ha} & {F}_{ha}\end{matrix} ]}^{T} , \qquad ( 18 )$$

$${X}_{ta} = {[ \begin{matrix}{x}_{ta} & {\dot{x}}_{ta} & {F}_{ta}\end{matrix} ]}^{T} \qquad ( 19 )$$

where the subscripts b, ha, and ta mean body, head actuator, and tail actuator respectively. Specifically, X_{b} is described by (11) and (15). Xₕₐ and Xₜₐ are described by two individual (8). When simulating the robot, all states are set to zero initially and the magnitude and timing of the pressure inputs can be specified manually or through the gait generator that will be introduced next.

### IV. Locomotion

### A. Gait Generation

An open-loop CPG is used to generate the periodic pressure commands for the three segments for efficient locomotion. CPGs are a group of coupled oscillators that generate rhythmic joint trajectories from non-rhythmic inputs. By adjusting the gait parameters such as period, phase offsets, and duty factors, the in-pipe robot will be able to move forward or backward at various speeds. In the present disclosure, the CPG has three oscillators whose phases are coupled through the following equation:

$${\dot{ϕ}}_{i} = 2 π f + {\sum }_{j = 1}^{3} {α}_{ϕ} {c}_{ij} sin ( {ϕ}_{j} - {ϕ}_{i} - {ψ}_{ij} ) , \qquad ( 20 )$$

where f is the gait frequency, α_{ϕ=}10 is a constant controlling the convergence rate, and {i, j}={1,2,3} which indexes the oscillator for the body, head, and tail segments, respectively. cᵢⱼ describes the coupling strength between oscillators and

$${c}_{ij} = \{ \begin{matrix}0 , & i = j \\ 1 , & i \neq j\end{matrix} . {ψ}_{ij}$$

is an element from the matrix ψ which describes the desired phase difference between oscillators as shown below:

$$ψ = [ \begin{matrix}0 & {ψ}_{12} & {ψ}_{13} \\ - {ψ}_{12} & 0 & {ψ}_{13} - {ψ}_{12} \\ - {ψ}_{13} & - ( {ψ}_{13} - {ψ}_{12} ) & 0\end{matrix} ] .$$

Since the supply pressure is fixed and either a constant positive or negative input pressure is applied to the in-pipe robot, the phase of each oscillator, wrapped into [0, 2π), is converted to a binary output with a duty factor parameter dᵢ as in

$${u}_{i} = \{ \begin{matrix}1 , & {ϕ}_{i} > 2 π {d}_{i} \\ 0 , & otherwise\end{matrix} ,$$

where an output of 1 means applying positive pressure and 0 means applying negative pressure.

### B. Gait Optimization for Highest Robot Speed

With the calibrated in-pipe robot model, a gait optimization that tries to maximize forward speed is conducted on the following CPG parameters: period of a cycle 1/fϵ(2,4)s, phase offset between body and head ψ₁₂ϵ(0, 21), phase offset between body and tail ψ₁₃ξ(0, 2π), duty factor of body d₁ϵ(0.2, 0.8), and duty factor of head and tail d₂=d₃ϵ(0.2, 0.8). For each trial, the in-pipe robot is simulated for four cycles and the speed of the final settled cycle is used. It was noticed that the routine tends to find a gait that slips forward, which was hard to reproduce in reality; mainly due to slight misalignment and actuator bending. Therefore, if slipping is detected that is \dot{x}ₕ and \dot{x}ₜ are both nonzero, a zero speed is returned. Moreover, a zero will also be returned if a simulation run takes too long to complete. The positive and negative supply pressure in the simulation are −13 psi and 8.5 psi, respectively.

The optimizer is Bayesian Optimization paired with an Upper Confidence Bound acquisition function with κ=0.5 favoring exploitation. Three runs with 1000 iterations each are performed with different random seeds. The optimized gait parameters are directly deployed on the real in-pipe robot for three trials and the head displacement and pressure data are collected at 100 Hz.

For comparison, a baseline gait is also performed both in simulation and experiments where the duty factors are all set to 0.5, the phase differences ψ₁₂=1.51π, ψ₁₃=0.5π and the period 1/f=5.7 s are selected so that the body segment switches state only when the head segment or tail segment fully anchors. It is believed that this gait is a reasonable baseline since it can be implemented easily without CPG and requires minimal tuning.

C. Locomotion sequence

A method corresponding with a simplified locomotion sequence includes: modifying, by a fluid pressure control device (e.g., fluid pressure control device 300), a first fluid pressure within a tail segment (e.g., tail segment 130) of a robot according to a first periodic pressure command cycle, the tail segment having a first subset of actuator units of a plurality of actuator units; modifying, by the fluid pressure control device, a second fluid pressure within a body segment (e.g., body segment 110) of the robot according to a second periodic pressure command cycle having a first phase offset relative to the first periodic pressure command cycle, the body segment having a second subset of actuator units of the plurality of actuator units; and modifying, by the fluid pressure control device, a third fluid pressure within a head segment (e.g., head segment 120) of the robot according to a third periodic pressure command cycle having a second phase offset relative to the first periodic pressure command cycle, the head segment having a third subset of actuator units of the plurality of actuator units.

In an example locomotion sequence, the tail segment transitions to the expanded state such that the feet of the tail segment contact an interior surface of the pipe at a first location (i.e., by transitioning the first subset of actuator units of the tail segment into an extended state by increasing the first fluid pressure by the fluid pressure control device such that one or more feet of the tail segment contact an interior surface of a pipe at a first location). The head segment is in the contracted state.

The body segment then transitions to the extended state (i.e., by transitioning the second subset of actuator units of the body segment into an extended state by increasing the second fluid pressure by the fluid pressure control device such that a length of the body segment increases while the one or more feet of the tail segment maintain contact with the interior surface of the pipe at the first location), extending its overall length. Because the tail segment contacts the pipe at the first location, but the head segment is free, extension of the body segment moves the head segment to a second location along the interior surface of the pipe.

The head segment then transitions to the extended state, i.e., by transitioning the third subset of actuator units of the head segment into an extended state by increasing the third fluid pressure by the fluid pressure control device such that one or more feet of the head segment contact the interior surface of the pipe at the second location. The tail segment can then decouple from the first location along the interior surface of the pipe, i.e., by transitioning the first subset of actuator units of the tail segment into a contracted state by decreasing the first fluid pressure by the fluid pressure control device such that the one or more feet of the tail segment decouple from the first location of the interior surface of the pipe.

Following decoupling of the tail segment from the first location, the body segment contracts to draw the tail segment towards a third location along the interior surface of the pipe, i.e., by transitioning the second subset of actuator units of the body segment into a contracted state by increasing the second fluid pressure by the fluid pressure control device such that the length of the body segment decreases while the one or more feet of the head segment maintain contact with the interior surface of the pipe at the second location. The tail segment can then expand to contact the interior surface of the pipe at the third location, i.e., by transitioning the first subset of actuator units of the tail segment into the extended state by increasing the first fluid pressure by the fluid pressure control device such that the one or more feet of the tail segment contact the interior surface of the pipe at a third location.

Once again, the process continues by first decoupling the head segment from the third location of the pipe (i.e., transitioning the third subset of actuator units of the head segment into the contracted state by decreasing the third fluid pressure by the fluid pressure control device such that the one or more feet of the head segment decouple from the second location of the interior surface of the pipe), extending the length of the body segment to position the head segment at a fourth location (i.e., transitioning the second subset of actuator units of the body segment into the extended state by increasing the second fluid pressure by the fluid pressure control device such that the length of the body segment decreases while the one or more feet of the head segment maintain contact with the interior surface of the pipe at the third location), and expanding the head segment to contact the pipe at the fourth location (i.e., transitioning the third subset of actuator units of the head segment into the extended state by decreasing the third fluid pressure by the fluid pressure control device such that the one or more feet of the head segment contact the interior surface of the pipe at a fourth location). The process continues as needed.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

### V. Experiments

A series of experiments were performed on both the actuator and robot levels to study the impact of the high-power motion resulting from the bistability. Specifically, static loading, step response, impact, and push tests were performed for one soft and one stiff body actuator as mentioned in Section II-C-3 and shown in FIGS. 7A and 7B. Static loading and step response tests were also performed on one head or tail actuator for system identification. Two complete robots were built, one with the soft body actuator and one with the stiff body actuator to study how the material stiffness affects the speed and power output of the robot. Their speeds in pipes of different diameters and connected with various angled elbows were measured. For all the experiments, the commanded positive pressure is 5 psi, the minimum pressure needed to reliably trigger the stiff body actuator. A unregulated vacuum pressure of around −13 psi is used. Five trials were performed for each individual experiment.

### A. Actuator Characterization

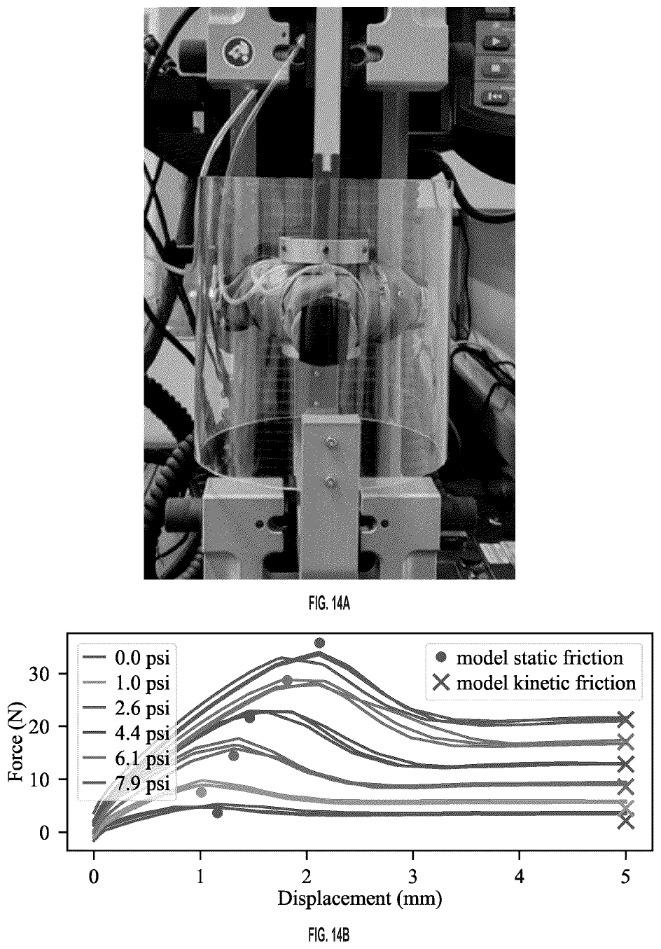

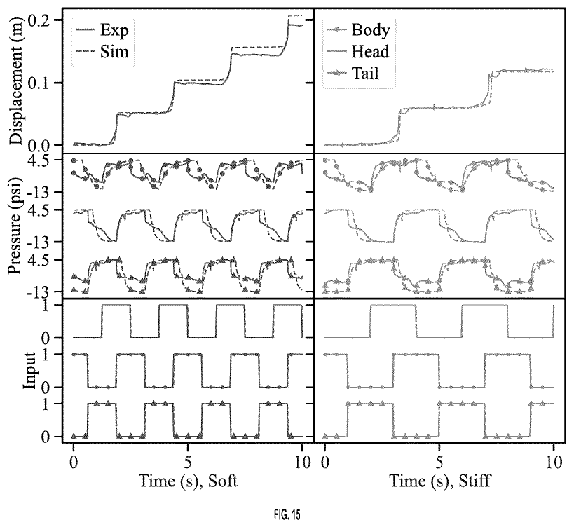

1) Static Loading: This test allows us to measure and compare the stiffness curves of the actuators. With a universal testing system (Instron, 5944), the actuator was slowly pulled from its contracted state until fully extended and pushed back, as shown in FIG. 13A. Each actuator was tested with and without positive pressure. Force and displacement data were recorded at 50 Hz.

2) Step Response: The goal of this test is to quantify the response time and dynamics of the actuators. During testing, the actuator started from its contracted state with negative pressure applied, and its bigger end was mounted on a testing stand. Then, the positive pressure was applied followed by negative pressure with some time delay. Shown in FIG. 13B, a motion capture system (NaturalPoint, OptiTrack Prime 17 W) was used to collect the position data of the smaller end, and the pressure sensor data was also recorded, both with a sampling rate of around 100 Hz.

3) Impact: This test enables us to compare the impact force generated by the two body actuators and study its relationship with the steady-state pushing force. For this test, a load cell (Geekstory, 20 kg) was mounted 0 to 50 mm with a 5-mm increment above a grounded actuator, as shown in FIG. 13C. The actuator started under negative pressure and a positive pressure was applied. The end of the actuator accelerated and hit the load cell, producing an impact force. When the end fully stopped and the pressure stabilized, the actuator exerted a steady-state pushing force to the load cell. The force data from the load cell was recorded at around 2000 Hz.

4) Push: To study how bistability affects the actuator's energy output capability, a pushing test is used. The actuator was first mounted horizontally and vacuumed, and a positive pressure was then applied to push an object fixed on a linear slider 0 to 50 mm with a 10-mm increment away, as shown in FIG. 13D. The same motion capture system was used to record the position data of the object being pushed at around 250 Hz. The data were used to calculate the object's speed and, therefore, the kinetic energy transferred from the actuator.

5) Simulation: These experiment data were also used to calibrate the model. A 15° polynomial fit of the measured stiffness curve gave us K and a is chosen so that the predicted stiffness curves with and without pressure are closest to the experiment data. m is directly measured from the parts. bₚ, bₙ, α, and τ were found by minimizing the root mean square error (RMSE) between the experiment and simulation displacement. The RMSE of the impact and steady-state force from the impact experiment compared to the simulation were minimized to calibrate k_{c} and b_{c}. Each type of actuator has its own set of parameter values as shown in Table III. The positive and negative supply pressure measured from the experiment were used for simulation. The model is numerically solved with LSODA from the SciPy package. The optimizer is differential evolution from SciPy.

### B. Head/Tail Anchor Characterization

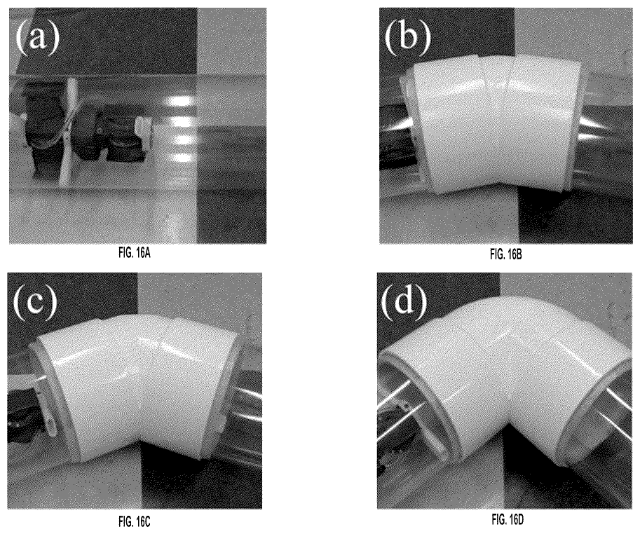

The anchoring capability of the in-pipe robot was measured by pulling the pressurized head segment from still through a pipe at 20 mm/s and recording the force and displacement data at 50 Hz. Three trials were performed on one sample of the head with different commanded pressures as shown in FIG. 14A.

Since the model is able to predict the normal force applied to the pipe wall, the maximum force before sliding and the force during sliding from the anchor characterization were used to find the pipe wall threshold x_{w}, as well as static friction coefficient us and kinetic μₖ friction coefficient, by minimizing the error between model prediction and experimental data.

The results from the anchor characterization are plotted in FIG. 14B. When pressurized, one head segment provides up to around 33 N of anchoring force. Even when there is no pressure, one segment can still provide about 5 N which is three times its body gravity if using both the head and tail, making the in-pipe robot well-suited to anchor both horizontally and vertically and resist disturbances.

### C. Robot Locomotion

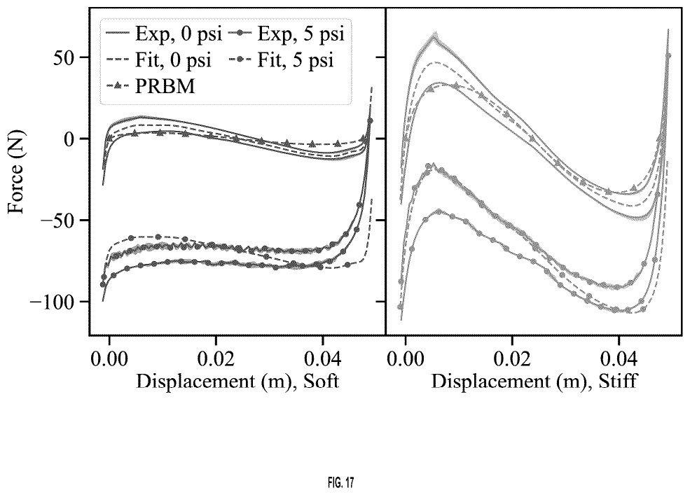

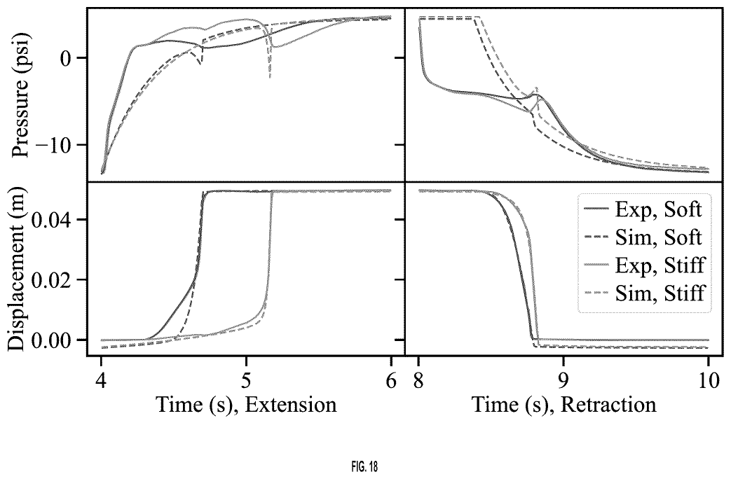

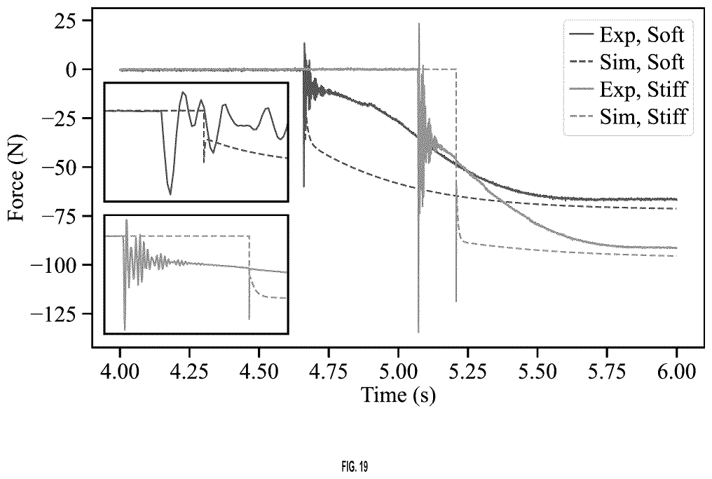

To find the robot's fastest stable gaits when different body actuators are attached, the period of the gait pattern as shown in FIG. 15 is hand-tuned with 0.5-s step, while keeping the phase offsets and duty cycles the same. Once the gaits are determined for both the soft and stiff body actuators, the robot is then commanded to crawl through a straight pipe as well as two pipes connected by 22.5°, 45°, and 90° elbows, as shown in FIGS. 16A-16D. Two pipe diameters of roughly four inches and six inches are tested. The speed for each scenario was recorded.

In addition, when the robot was moving inside the straight 6-in pipe, the displacement data of the robot head from the motion capture system, along with the pressures and input commands, were also recorded. The same experiments were also carried out in simulation for comparison.

### VI. Results and Discussions

### A. Actuator Characterization

1) Static Loading: The stiffness curves of the soft and stiff body actuator from the static loading tests are plotted in FIG. 17. There is obvious hysteresis due to material internal energy loss. The range of force for the stiff actuator is much larger than that for the soft one. This will result in different minimum operation pressures for the robot.

Moreover, when comparing the shifted polynomial fit to the stiffness curve of the pressurized actuator, it is clear that the shape of the curve does change a little, which is more obvious for the soft one. This indicates that the effective area for the pneumatic force is not exactly constant throughout the actuator's deformation range due to the deformation of the bistable structure, but a constant assumption as in (6) is a reasonable approximation. The identified areas a for both the soft and stiff body actuators are listed in Table III, and they are almost identical as expected since the geometry of the two actuators is the same.

Finally, the PRBM produces stiffness curves are similar to the measured ones for both actuators. The differences are partially caused by the assumption related to (2). Although most parts on each layer of the flexing laminate section are separate, their ends are still adhered and stapled together and prevented from sliding freely, which the PRBM does not account for. Moreover, the flexure joints in the laminate devices are not exactly pin joints, which may be another contributing factor to the discrepancies. Despite these limitations, the PRBM is a useful tool for estimating the stiffness curves of BIFAs with a first-principle approach during the design stage. Once an actuator is fabricated and measured, a polynomial fit of the stiffness curve can be used for a more accurate model.

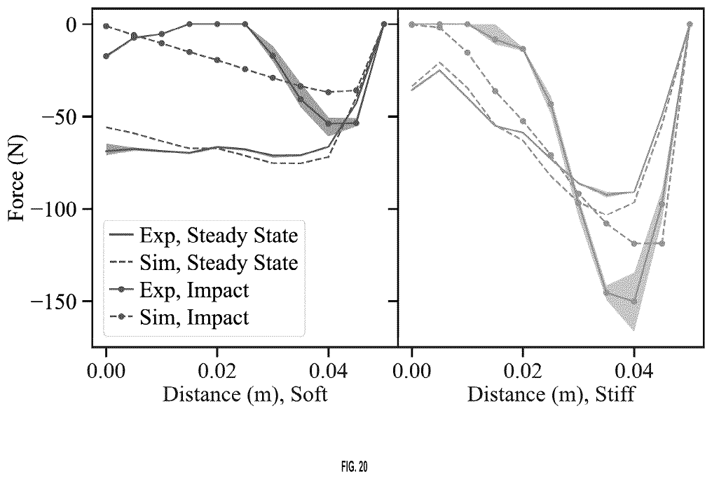

2) Step Response: The step responses of the pressure and displacement data of the soft and stiff body actuator are plotted in FIG. 18. First of all, when looking at the displacement plots, there are two main phases for the actuator deformation after pressure is applied. The first phase is significantly slower since the pressure is trying to deform the spring in the bistable structure. In the second phase, the energy stored in the spring and the pneumatic force both accelerate the actuator's end, resulting in a highspeed, high-power motion. Moreover, the response time of the stiff actuator is longer than the soft one, indicating that there is a tradeoff between robot speed and power. The difference is less obvious for retraction since the vacuum pressure is much larger than the positive one. Lastly, in the pressure plots, there are also local pressure valleys and peaks when the actuators transition between contracted and extended states, resulting from the rapid volume change. These can be a useful propreceptive signal to detect state transitions of the BIFAs.

In addition, the model is able to describe both actuators' responses well. The model exhibits the same two phases for the displacement and local pressure valleys and peaks with similar timings. The bigger differences in pressure are attributed to the simplified pressure model and remote placement of the pressure sensor. The identified bₚ, bₙ, α, and τ for both the soft and stiff body actuators are listed in Table III. Most of them share similar values between the two variants, which is reasonable since these values are mostly related to the geometry and pressure sources. One exception is that the negative pressure damping bₙ for the soft one is almost three times larger than the stiff one. This is probably because the stiffer spring inside the actuator after the triggering point helps with the vacuuming process by contributing its stored energy to push the air out.

3) Impact: For the impact test, the force data for the soft and stiff body actuator hitting the load cell 40 mm away are plotted in FIG. 19 as an example. Interestingly, there is an impact force before the force settles to the steady state in both the experiment and simulation data. For the stiff actuator, the impact force even exceeds the magnitude of the steady state one. This unique behavior is a result of the higher power motion and improves its ability to destroy certain blockages or obstacles inside the pipes.

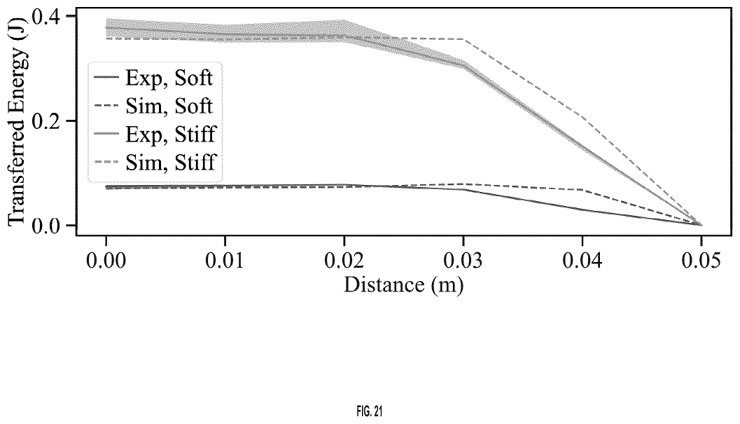

However, when looking at FIG. 20 where the impact and steady-state force are plotted against the initial distance between the actuator and load cell, this impact force is not always larger than the steady-state force, and it can be small. For the stiff actuator, the impact force becomes larger than the steady state one if the object is placed at least about 30 mm away, where the bistable structure starts to push the actuator's end away as in FIG. 17 and the actuator reaches the high-speed phase as in FIG. 18. In addition, the stiff actuator can also produce a larger steady-state force than the soft one around that range, thanks to the additional force provided by the stiffer bistable structure. Therefore, to produce a large impact and steady-state force, the robot equipped with a stiff actuator is preferred, but it needs to be placed at an appropriate distance from the target.

Despite the simplicity of the contact model, it is able to produce similar trends to the experiment in terms of the impact forces compared to the steady-state forces. The steady-state forces also match better since they depend less on the dynamic contact properties. Moreover, fabrication and measurement imperfections both affect the exact force amplitudes and contact timings, which also cause discrepancies between the model predictions and experimental results.

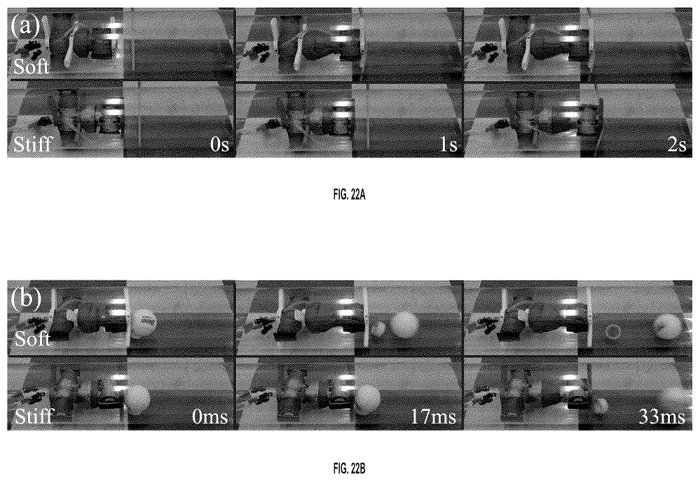

4) Push: As shown in FIG. 21, the stiff actuator is able to transfer almost five times the energy to the object during the push tests. As the initial distance between the object and actuator goes over about 30 mm, the energy transferred drops quickly, probably because collisions at higher speeds lose more energy. Therefore, if a robot wants to push away an object the furthest, it needs to move closer to the object. Moreover, the transferred energy for both soft and stiff actuators is about 60% of the spring energy stored in the bistable structure, which is estimated from the positive area under the stiffness curve. Lastly, the model captures the trend of the energy transfer during pushing objects well.

TABLE I
Body Actuator Performance Comparison

| | Extension | Contraction | Impact | Steady-state | Transferred |
|---|---|---|---|---|---|
| Type | time (s) | time (s) | force (N) | force (N) | energy (J) |
| Soft | 0.74 | 0.79 | 54.0 | 71.1 | 0.078 |
| Stiff | 1.18 | 0.83 | 150.3 | 92.5 | 0.377 |

In summary, it is the interplay between the bistable laminate spring and the pneumatic force of the BIFA that alters its performance. The model in Section III can describe and predict its behaviors with reasonable accuracy.

Conceptually, during the extension or contraction of the actuator, the bistable spring temporarily stores the energy provided by the relatively slow-changing pneumatic force and then releases it at a much faster rate, modulating the power output and generating a short-term high-power motion. Based on the comparison between the soft and stiff variants, it is clear that a stiffer spring is more desirable for storing more energy and achieving higher-power outputs. As summarized in Table I, the stiff variant generates almost three times the impact force (150.3 N versus 54.0 N) and transfers five times the energy to other objects (0.377 J versus 0.078 J).

Moreover, as shown in FIG. 17, the unique change in the spring force direction of the bistable spring also amplifies the maximum steady-state force output of the actuator since it adds a spring force to the pneumatic force. The increase is about 30% (92.5 N versus 71.1 N) when comparing the two variants as shown in Table I.

The proposed PRBM in Section III-A also provides good guidelines on maximizing the peak force and energy storage of the bistable spring by changing the structure of the actuator. It should be noted that the maximum stiffness will be limited by the maximum pneumatic force available, since the bistable spring needs to be triggered or displaced beyond the unstable equilibrium point to provide the amplification.

Lastly, tradeoffs exist between the speed and power of the actuator. If response time and speed are priorities, a softer spring is more desirable since it takes less energy and, thus, time for the same pressure source to deform. The actuator can also be easily tuned toward this goal thanks to the proposed design and fabrication methods.

TABLE II
Robot Speeds in Different Pipes

| Body | Pipe (in) | Elbow (°) | Speed ± SD (m/s) |
|---|---|---|---|
| Soft | 6 | 0 | 0.021 ± 0.08e−3 |
| Soft | 6 | 22.5 | 0.018 ± 0.30e−3 |
| Soft | 6 | 45 | 0.017 ± 0.65e−3 |
| Soft | 6 | 90 | 0.014 ± 0.89e−3 |
| Stiff | 6 | 0 | 0.011 ± 0.10e−3 |
| Soft | 4 | 0 | 0.018 ± 0.06e−3 |
| Stiff | 4 | 0 | 0.013 ± 0.06e−3 |

### B. Robot Locomotion

The speeds of the robot in different pipes are listed in Table II. Based on hand tuning, we found out that the robot with the soft body actuator can reliably move inside both 4-in and 6-in pipes with a gait period of 2.5 s. In contrast, the robot with the stiff body actuator needed a gait period of 4 s. This difference in maximum operation frequency is expected since the stiffer actuator responds slower to step input as previously mentioned and shown in FIG. 18. It further confirms that maximum speed will be sacrificed if the robot's body stiffness is increased for better power output capability while keeping the operating pressures and stroke length the same.

In addition to the speed difference, the robot's ability to negotiate with bent pipes is also different. The robot with the soft body actuator is able to passively adjust the orientation and move through pipe elbows from 22.5° to 90° in the 6-in pipe thanks to the body compliance and small body diameter. The speed drops and the standard deviation increases as the elbow angle increases because of the uncertain slippage during turning. The stiff robot can actually go through the less bent elbows, but not without damaging the fiberglass sheets inside the body actuator due to the pneumatic and contact force deforming its body along nonaxial directions. Therefore, the stiff robot is considered incapable of moving in bent pipes, and the speeds were not measured. For 4-in pipes, both types of the robot can not pass through any pipe elbows because the widest part of the robot is about three inches, and the robot is longer than the elbow, leaving very little space for turning. However, both of them can move in the straight 4-in pipe with a similar speed to the 6-inch one.

Finally, as shown in FIG. 15, the proposed robot model successfully describes the robot's locomotion inside the straight 6-in pipe, showing the effectiveness of the model. However, some discrepancies do exist. For the pressure data, the tail segment reports a smaller pressure range in experiments, which is probably caused by the routing of the pneumatic lines and airflow between different segments. Since the assumes that each segment operates independently, it does not account for this difference. Moreover, the head and tail actuators may not be perfectly normal to the pipe wall during the anchoring process, causing the robot to slip forward and backward a bit for each cycle.

### C. Functional Demonstrations

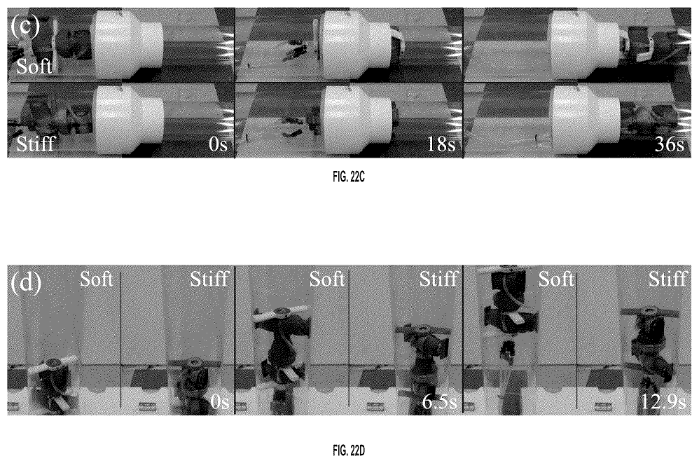

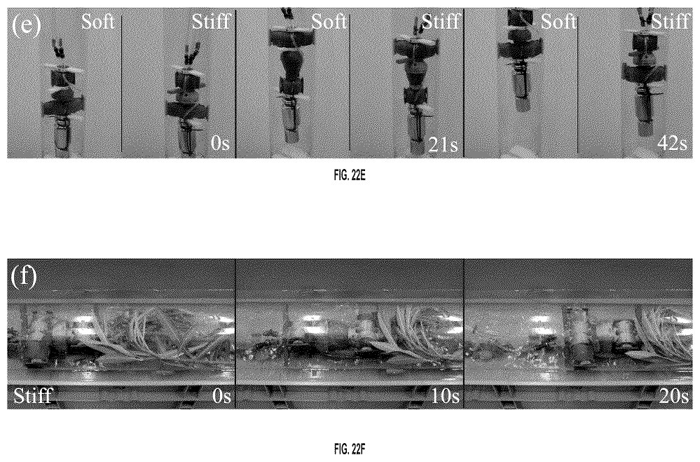

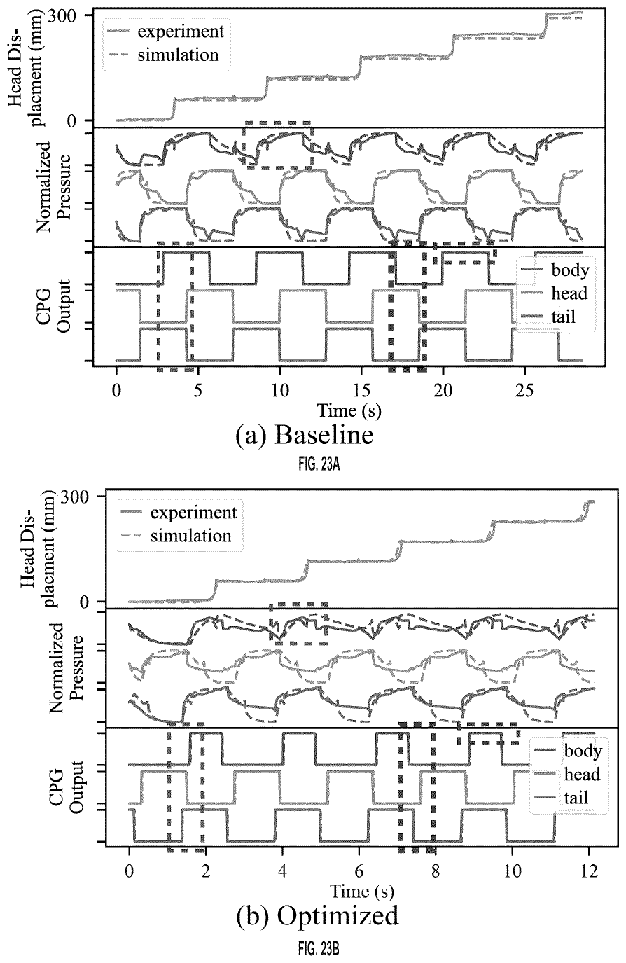

In addition to the quantitative experiments, a series of functional demonstrations were also performed as shown in FIGS. 22A-22F. First of all, the robot with both the soft and stiff body actuators was commanded to anchor its tail and use its head to hit a bundle of spaghetti 40 mm away, the optimum distance for impact force. It was observed that as the number of spaghetti increases, the soft variant would fail to break them first while the stiff one was still able to break the bundle, as shown in FIG. 22A. This further confirms the results from the impact test: the stiff body actuator is superior at providing higher impact force useful for breaking obstacles. It should be noted that since the impact force only exists for a very short time, it only benefits from breaking relatively brittle materials. For more elastic materials, the robot has to rely on steady-state force and displacement to break them.

Next, both types of robots were commanded to push a tennis ball right next to its head in the 6-in pipe. As shown in FIG. 22B, the stiff robot was able to launch the ball at a much greater speed, showing that the conclusions from the pushing test are also applicable to in-pipe scenarios.

Lastly, more locomotion scenarios were demonstrated. The robot was able to traverse between 4-in and 6-in pipes by passively deforming its supports. For squeezing into a smaller pipe, it was found that the soft variant needs to be slowed down to a 4-s gait period for the pressure to accumulate to exert enough force to reliably bend the supports, as shown in FIG. 22C. The robot is also able to climb along a vertical 6-inch pipe with a gait that partially overlaps the head and tail anchoring, as shown in FIG. 22D The gait period stays the same as those used in horizontal pipes. Both variants can also carry loads of up to 3 kg, more than ten times their body weights, when climbing up vertically if a slower gait with a period of 6 s is used as shown in FIG. 22E. Unintended deformation of the tail and head and foot slippage did happen under this condition, causing more speed variations. Moreover, thanks to its water-resistant nature, the robot can operate in a pipe with water, rocks, and tree branches without any modifications, as shown in FIG. 22F. Slippage of the anchoring was observed caused by water wetting the friction tape on the robot's feet and reducing their friction, which can be addressed by switching to different foot materials such as rubber pads or changing the feet geometry to have teeth that can grab onto the pipe wall.

### D. CPG-based Gait Optimization

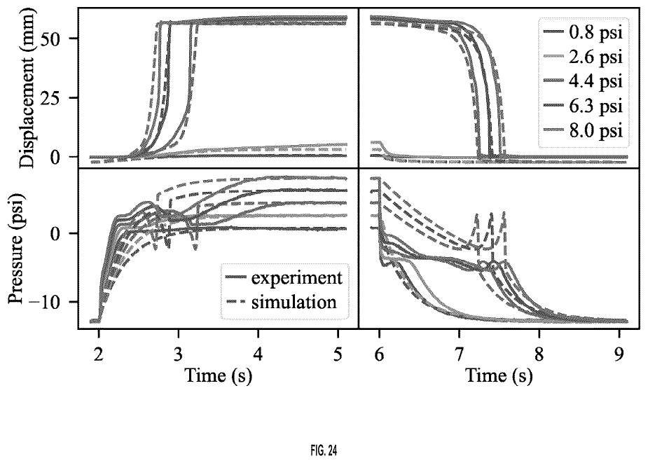

The results for the baseline and optimized gait from simulation and one trial of the experiment are plotted in FIGS. 23A and 23B. The average speed over five actuation cycles for three trials is 10.8±0.1 mm/s for the baseline and 23.3±0.1 mm/s for the optimized gait, showing a 120% improvement. As shown in the first two rows, the simulation and experimental data match very well, which showcases an effective use of simulation for gait optimization. The small mismatch of the displacement for the baseline gait is likely related to the underestimation of the maximum travel length of the body segment when the internal pressure reaches a steady state as evident in FIG. 24.

Comparing the plots of the baseline and optimized gait, three main approaches were identified that the optimizer used to improve the in-pipe robot's speed. First, it allocated more time for body contraction than extension with d_{b}=0.66 compared to d_{b}=0.5 used in the baseline gait as circled out by the brown box, because the contraction has to deal with the bulging effect of the fabric mentioned previously. Second, since the delay between receiving an extension/contraction command and the actual extension/contraction was longer for the body segment than the head/tail segment as hinted by FIG. 24, it is possible to start the anchoring of the head or tail segment around the same time as the state change command is issued for the body segment instead of inserting a long wait. This was evident from the CPG output plots where the state switching of the head and tail are closer to the body for the optimized gait as circled out by the red and purple boxes. Lastly, the internal pressure of the actuators only needs to apply enough force to overcome the peak force of the BIFAs instead of the supply pressure. In the pressure plots, the body pressure for the baseline gait is closer to settling after each transition than the body pressure during the optimized gait as circled out by the magenta box.

### E. Further Remarks

To improve the force and energy output capability of soft pneumatic in-pipe robots, the present disclosure outlines BIFAs that utilize their bistable laminate springs to modulate the available pneumatic power and generate short-term high-power motions. By comparing a soft and stiff variant of the body actuator, it was found that these high-power motions can be used to generate high impact forces for breaking objects or launching objects at higher speeds. The stiff variant achieves almost three times the impact force and five times the energy output. Interestingly, these capabilities were also related to the distance between the actuator and the object.

A robot is also built with these actuators to demonstrate the benefits of the impact force and energy output amplifications in the pipes. Unfortunately, this high power output sacrificed the robot's top speed and compliance for negotiating bent pipes.

In addition, the present disclosure provides a PRBM for the bistable spring, a reduced-order model for the actuator with and without contacts, and a robot model extended from the actuator. These models were simple to implement, fast to compute, and captured the key system characteristics well.

Refinement of the robot may further focus on improving the reliability and performance of BIFAs through exploring new materials and fabrication methods. Advanced localization and control techniques are also important for the robot to adapt to the pipe environments autonomously. More gait parameters can be tuned and tested to further optimize the robot's speed in different scenarios. In addition, the feet can be further optimized to reduce slippage in wet conditions. Organizing the pneumatic lines and reducing their resistance against locomotion are important. Cameras and other sensors may be mounted on the robot to collect data inside pipes.

VII. Performance Comparison with Existing In-Pipe Robots

The present disclosure outlines improvements to small power output capability of soft pneumatic in-pipe robots by integrating bistability into the actuators, since it can be useful for pushing away or even breaking obstacles to allow passage and inspection. Moreover, no soft pneumatic in-pipe robots are designed with this goal in mind. There are also no established performance metrics to compare against.

However, other performance metrics such as weight, speed, operational pipe diameter range, and maximum payload are also important for in-pipe robots. Therefore, performance values of some the existing robots compared to those of two variants outlined in this disclosure are listed in Table III. The shortest length of the robot is used if the robot can change its length. While a robot's speed may vary based on the environment, its maximum speed reported is used.

Since the robots vary a lot in size and weight, some normalized performance are included in Table IV. The density of a robot refers to the mass divided by the cylindrical volume taken by the robot in the biggest pipe it can operate in. A lower density indicates that the robot is lighter. The diameter ratio refers to the minimum diameter divided by the maximum one of the pipes that a robot can operate in, meaning that the lower the diameter ratio the wider range of pipe size the robot can operate in. The speed is normalized against the total body length (BL) of a robot. The maximum load capacity is normalized against the body weight (BW) of a robot.

Comparing normalized performance of the robot of the present disclosure against the median of existing robots, the robot of the present disclosure is on the lighter side and can adapt to a wider range of pipe diameters. The soft variant has a speed comparable to existing designs. While the stiff variant has a lower speed, it offers significant impact force and energy output amplification, which are lacking in other robots. The maximum load capacity is also similar to the existing ones. In addition to the quantitative data, the robot of the present disclosure, like some other soft pneumatic in-pipe robots, should also be easier to waterproof and cost less to fabricate compared to more rigid ones made from motors and metal parts.

TABLE III
Performance Comparison with Existing In-Pipe Robots

| | | Min. | Max. | | | | |
|---|---|---|---|---|---|---|---|
| | Weight | Diameter | Diameter | Length | Speed | Max. Load | Tested in |
| Robot | (kg) | (m) | (m) | (m) | (m/s) | (kg) | Water |
| [1] | 45.800 | 0.950¹ | 1.200¹ | 0.675² | 0.088 | | N |
| [2] | 1.800 | 0.154 | 0.202 | 0.235 | 0.069 | | N |
| [6] | 0.700 | 0.109¹ | 0.129¹ | 0.176 | 0.500 | | N |
| [8] | 2.370 | 0.102 | 0.127¹ | 0.440 | 0.080 | 20.600³ | N |
| [10] | 0.098 | 0.060 | 0.064 | 0.058² | 0.004 | 1.381⁴ | Y |
| [11] | 0.086 | 0.054 | 0.059 | 0.071² | 0.005 | 1.000⁴ | Y |
| [12] | 0.050 | 0.090 | 0.120 | 0.118² | 0.015 | 0.284⁴ | Y |
| [13] | 0.196 | 0.152 | 0.152 | 0.156 | 0.008 | | N |
| [14] | 0.017² | 0.026 | 0.051 | 0.088 | 0.001² | | N |
| [15] | 0.057 | 0.051 | 0.057 | 0.153 | 0.033 | 0.496³ | Y |
| [16] | 0.080 | 0.056 | 0.071 | 0.154 | 0.035 | 1.000⁴ | N |
| This work, | 0.284 | 0.102 | 0.152 | 0.175 | 0.021 | 3.000 | Y |
| soft | | | | | | | |
| This work, | 0.284 | 0.102 | 0.152 | 0.175 | 0.011 | 3.000 | Y |
| stiff | | | | | | | |

¹It is not clear whether these values have been tested in actual pipes.
²These values are estimated based on the figures in the paper.
³The maximum continuous traction force reported.
⁴The downward load on the robot climbing against gravity excluding its own weight.

TABLE IV
Performance Comparison with Existing In-Pipe Robots

| | | Diameter Ratio | | |
|---|---|---|---|---|
| Robot | Density (kg/m³) | (%) | Speed (BL/s) | Load (BW) |
| [1] | 60 | 79.2 | 0.13 | |
| [2] | 239 | 76.2 | 0.29 | |
| [6] | 304 | 84.5 | 2.84 | |
| [8] | 425 | 80.3 | 0.18 | 8.7 |
| [10] | 524 | 93.8 | 0.07 | 14.1 |
| [11] | 443 | 91.5 | 0.07 | 11.6 |
| [12] | 37 | 75.0 | 0.13 | 5.7 |
| [13] | 69 | 100.0 | 0.05 | |
| [14] | 96 | 51.0 | 0.01 | |
| [15] | 146 | 89.5 | 0.22 | 8.7 |
| [16] | 131 | 78.9 | 0.23 | 12.5 |
| Median | 146 | 80.3 | 0.13 | 10.2 |
| This work, soft | 89 | 67.1 | 0.12 | 10.6 |
| This work, stiff | 89 | 67.1 | 0.06 | 10.6 |

TABLE V
Model Parameters and Values

| Name | Symbol | Value | Unit |
|---|---|---|---|
| PRBM | | | |
| Link width | w | 0.0230 | m |
| Half link length | l | 0.0173 | m |
| Fully bent distance | l_{b’c} | 0.0230 | m |
| Fiberglass sheet Young's modulus | E_{f} | 17.0 | GPa |
| Polyester sheet Young's modulus | Eₚ | 5.00 | GPa |
| Soft Body Actuator | | | |
| Cross-section area | a | 2.04e−3 | m² |
| Smaller end mass | m | 0.017 | kg |
| Pressure convergence factor | α | 2.85 | N/(m/s) |
| Positive pressure damping | bₚ | 54.5 | N/(m/s) |
| Negative pressure damping | bₙ | 314 | N/(m/s) |
| Negative pressure time delay | τ | 0.383 | s |
| Contact stiffness | k_{c} | 9760 | N/m |
| Contact damping | b_{c} | 52.7 | N/(m/s) |
| Stiff Body Actuator | | | |
| Cross-section area | a | 1.98e−3 | m² |
| Smaller end mass | m | 0.017 | kg |
| Pressure convergence factor | α | 2.52 | N/(m/s) |
| Positive pressure damping | bₚ | 54.4 | N/(m/s) |
| Negative pressure damping | bₙ | 118 | N/(m/s) |
| Negative pressure time delay | τ | 0.423 | s |
| Contact stiffness | k_{c} | 16400 | N/m |
| Contact damping | b_{c} | 71.3 | N/(m/s) |
| Head and Tail Actuator | | | |
| Cross-section area | a | 0.943e−3 | m² |
| Smaller end mass | m | 0.013 | kg |
| Pressure convergence factor | α | 6.44 | N/(m/s) |
| Positive pressure damping | bₚ | 38.1 | N/(m/s) |
| Negative pressure damping | bₙ | 48.0 | N/(m/s) |
| Negative pressure time delay | τ | 0.200 | s |
| Contact stiffness | k_{c} | 9760 | N/m |
| Contact damping | b_{c} | 52.7 | N/(m/s) |
| Robot | | | |
| Static friction coefficient | μₛ | 0.9 | |
| Kinetic friction coefficient | μₛ | 0.72 | |
| Friction switch threshold | ∈ | 1e−6 | m/s |
| Half mass | m | 0.142 | kg |
| Gravitational acceleration | g | 9.81 | m/s² |
| Pipe wall distance | xₒ | 0.0355 | m |

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A bistable laminate actuator unit, comprising:
a flexible device coupled to a base unit, the base unit including a first connector coupled to a first portion of the flexible device and a second connector of the base unit coupled to a second portion of the flexible device;
wherein the second connector nests within the first connector and the second portion of the flexible device extends inward relative to the first connector when in a contracted state; and
wherein the second connector extends away from the first connector and the second portion of the flexible device extends outward relative to the first connector when in an extended state.

2. The bistable laminate actuator unit of claim 1, the base unit further comprising:
a balloon spanning the first connector and the second connector, the balloon being in fluid flow communication with a fluid pressure control device;
wherein application of a negative pressure or a positive pressure within the balloon by the fluid pressure control device respectively configures the flexible device in the contracted state or the extended state.

3. The bistable laminate actuator unit of claim 2, wherein deflation of the balloon by the fluid pressure control device collapses the second connector into the first connector, thereby transitioning the flexible device into the contracted state.

4. The bistable laminate actuator unit of claim 2, wherein inflation of the balloon by the fluid pressure control device pushes the second connector away from the first connector, thereby transitioning the flexible device into the extended state.

5. A robot, comprising:
a body including an actuator unit, the actuator unit including a flexible device coupled to a base unit, wherein the flexible device is selectively configurable for setting the actuator unit in a contracted state or an extended state based on a fluid pressure within the base unit; and
a fluid pressure control device in fluid flow communication with the actuator unit, the fluid pressure control device being operable for controlling the fluid pressure within the actuator unit.

6. The robot of claim 5, the actuator unit including:
a proximal portion including a first connector of the base unit coupled to a first portion of the flexible device;
a distal portion including a second connector of the base unit coupled to a second portion of the flexible device, wherein the second connector nests within the first connector when the actuator unit is in the contracted state; and
a balloon spanning the first connector and the second connector, the balloon being in fluid flow communication with the fluid pressure control device;
wherein application of a positive pressure or negative pressure within the balloon by the fluid pressure control device respectively sets the actuator unit in the contracted state or the extended state.

7. The robot of claim 6, wherein deflation of the balloon by the fluid pressure control device collapses the second connector into the first connector, thereby transitioning the flexible device into the contracted state.

8. The robot of claim 6, wherein inflation of the balloon by the fluid pressure control device pushes the second connector away from the first connector, thereby transitioning the flexible device into the extended state.

9. The robot of claim 5, the body including:
a body segment including a first actuator unit of a plurality of actuator units;
a head segment engaged to a distal portion of the body segment, the head segment including a second actuator unit of the plurality of actuator units and a first foot positioned along a distal portion of the second actuator unit; and
a tail segment engaged to a proximal portion of the body segment, the tail segment including a third actuator unit of the plurality of actuator units and a second foot positioned along a distal portion of the second actuator unit.

10. The robot of claim 9, the head segment including:
a fourth actuator unit of the plurality of actuator units, the fourth actuator unit having a proximal portion coupled to a proximal portion of the second actuator unit, and the fourth actuator unit being oriented substantially coplanar with the second actuator unit; and
a third foot positioned along a distal portion of the fourth actuator unit.

11. The robot of claim 9, the tail segment including:
a fifth actuator unit of the plurality of actuator units, the fifth actuator unit having a proximal portion coupled to a proximal portion of the third actuator unit, and the fifth actuator unit being oriented substantially coplanar with the second actuator unit; and
a fourth foot positioned along a distal portion of the fifth actuator unit.

12. The robot of claim 9, wherein the fluid pressure control device is operable to propel the robot within a pipe structure by selectively inflating and deflating each respective actuator unit of the plurality of actuator units according to a periodic pressure command cycle.

13. The robot of claim 9, the second actuator unit of the head segment and the third actuator unit of the tail segment being oriented substantially orthogonal to a direction of elongation of the first actuator unit of the body segment.

14. The robot of claim 9, further including one or more rotors rotatable about a first axis corresponding with a direction of elongation of the body segment, each rotor of the one or more rotors defining a member being biased toward a straightened configuration and configured to elastically buckle upon application of an external force exceeding a threshold magnitude.

15. The robot of claim 14, further including a motor configured for rotating the one or more rotors responsive to one or more rotor control signals.

16. A method of actuating a robot within a pipe, the method comprising:
modifying, by a fluid pressure control device, a first fluid pressure within a tail segment of a robot according to a first periodic pressure command cycle, the tail segment having a first subset of actuator units of a plurality of actuator units;
modifying, by the fluid pressure control device, a second fluid pressure within a body segment of the robot according to a second periodic pressure command cycle having a first phase offset relative to the first periodic pressure command cycle, the body segment having a second subset of actuator units of the plurality of actuator units; and
modifying, by the fluid pressure control device, a third fluid pressure within a head segment of the robot according to a third periodic pressure command cycle having a second phase offset relative to the first periodic pressure command cycle, the head segment having a third subset of actuator units of the plurality of actuator units.

17. The method of claim 16, each actuator unit of the plurality of actuator units including:
a flexible device coupled to a base unit, the base unit including a first connector coupled to a first portion of the flexible device, a second connector of the base unit coupled to a second portion of the flexible device, and a balloon spanning the first connector and the second connector, the balloon being in fluid flow communication with the fluid pressure control device;
wherein deflation of the balloon by the fluid pressure control device collapses the second connector into the first connector, thereby transitioning the flexible device into a contracted state; and
wherein inflation of the balloon by the fluid pressure control device pushes the second connector away from the first connector, thereby transitioning the flexible device into an extended state.

18. The method of claim 16, further comprising:
transitioning the first subset of actuator units of the tail segment into an extended state by increasing the first fluid pressure by the fluid pressure control device such that one or more feet of the tail segment contact an interior surface of a pipe at a first location;
transitioning the second subset of actuator units of the body segment into an extended state by increasing the second fluid pressure by the fluid pressure control device such that a length of the body segment increases while the one or more feet of the tail segment maintain contact with the interior surface of the pipe at the first location; and
transitioning the third subset of actuator units of the head segment into an extended state by increasing the third fluid pressure by the fluid pressure control device such that one or more feet of the head segment contact the interior surface of the pipe at a second location.

19. The method of claim 18, further comprising:
transitioning the first subset of actuator units of the tail segment into a contracted state by decreasing the first fluid pressure by the fluid pressure control device such that the one or more feet of the tail segment decouple from the first location of the interior surface of the pipe;
transitioning the second subset of actuator units of the body segment into a contracted state by increasing the second fluid pressure by the fluid pressure control device such that the length of the body segment decreases while the one or more feet of the head segment maintain contact with the interior surface of the pipe at the second location; and
transitioning the first subset of actuator units of the tail segment into the extended state by increasing the first fluid pressure by the fluid pressure control device such that the one or more feet of the tail segment contact the interior surface of the pipe at a third location.

20. The method of claim 19, further comprising:
transitioning the third subset of actuator units of the head segment into the contracted state by decreasing the third fluid pressure by the fluid pressure control device such that the one or more feet of the head segment decouple from the second location of the interior surface of the pipe;
transitioning the second subset of actuator units of the body segment into the extended state by increasing the second fluid pressure by the fluid pressure control device such that the length of the body segment decreases while the one or more feet of the head segment maintain contact with the interior surface of the pipe at the third location; and
transitioning the third subset of actuator units of the head segment into the extended state by decreasing the third fluid pressure by the fluid pressure control device such that the one or more feet of the head segment contact the interior surface of the pipe at a fourth location.
